(19) United States
(12) Patent Application Publication
(10) Pub. No.: US 2018/0027518 A1
(43) Pub. Date: Jan. 25, 2018

(54) PROXIMITY SENSING USING SPECTRAL ANALYSIS

(71) Applicant: QUALCOMM Incorporated, San Diego, CA (US)

(72) Inventors: Karthikeyan Sugumaran, Bangalore (IN); Senthilkumar Murugesan, Bangalore (IN); Sathish Kumar Kannan, Chennai (IN)

(21) Appl. No.: 15/218,925

(22) Filed: Jul. 25, 2016

(51) Int. Cl. H04W 64/00; H04W 72/04

(52) U.S. Cl. CPC H04W 64/00; H04W 72/042; H04W 72/0413; H04W 84/12

(57) ABSTRACT

Methods, systems, and devices for wireless communication are described. An access point (AP) may transmit a reference waveform that is received by a station (STA) and the AP. The AP and the STA may perform spectral analysis on the received waveform to determine spectral characteristics of the waveform. The AP may receive, from the STA, spectral characteristics for the reference waveform as received at the STA and may compare the spectral characteristics from the STA to the spectral characteristics determined by the AP. If the spectral characteristics are similar, the AP may determine that the STA is within close proximity. If the spectral characteristics are different, the AP may determine that the STA is not within close proximity. The AP may authenticate the STA based on the sensed proximity of the STA.

### BACKGROUND

The following relates generally to wireless communication, and more specifically to proximity sensing using spectral analysis.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., IEEE 802.11) network, may include an access point (AP) that may communicate with one or more stations (STAs) or other mobile devices. The AP may be in communication with a network, such as the Internet, and thus may allow a mobile device or other wireless device to communicate via the network (or communicate with other devices in communication with the access point). A wireless device may communicate with a network device bi-directionally. For example, in a WLAN, a STA may communicate with an associated AP via uplink (UL) and downlink (DL). The DL (or forward link) may refer to the communication link from the AP to the station, and the UL (or reverse link) may refer to the communication link from the station to the AP.

An area of relevance for a wireless device may be the area in which the wireless device, such as an AP, provides service to other wireless devices that connect to the AP. In some cases, a STA and/or AP capable of wireless communications may be unaware when the STA or AP is located in an area of relevance. For example, the STA or AP may not support geo-location protocols such as global positioning system (GPS), near field communications (NFC), or other protocols or techniques that may help determine proximity information for the device. Lack of proximity information may result in a STA attempting to connect to an AP that is too far away to provide quality service, or in an AP providing service for a STA that is not authorized for service from the AP.

### SUMMARY

The described techniques relate to improved methods, systems, and devices, that support proximity sensing using spectral analysis. A reference waveform may be received both by a client device, such as a station (STA), and the AP. An auxiliary transmitter of the AP may be used to transmit the reference waveform. The AP may perform spectral analysis on the received waveform to determine spectral characteristics of the reference waveform. The spectral characteristics may be indicative of the wireless channel over which the reference waveform was received. In some cases, the spectral characteristics are derived from a spectrogram of the reference waveform, the spectrogram being a visual representation of the received signal, for example over time or frequency. The AP may receive, from the STA, spectral characteristics for the reference waveform as received at the STA. The AP may compare the spectral characteristics from the STA to the spectral characteristics determined by the AP, for example by correlating the spectral characteristics. If the spectral characteristics are sufficiently similar, the AP may determine that the STA is experiencing channel conditions similar to those experienced by the AP and that the STA is within close proximity. The AP may determine that the spectral characteristics are sufficiently similar based on a correlation coefficient that exceeds a first predetermined threshold. If the spectral characteristics are different, the AP may determine that the STA is experiencing channel conditions sufficiently different from those experienced by the AP and that the STA is not within close proximity. The AP may determine that the spectral characteristics are sufficiently different based on a correlation coefficient that is less than a second predetermined threshold.

The AP may authenticate the STA based on the sensed proximity. For example, the AP may issue the STA an authentication grant if the STA is within a threshold distance, and the AP may issue the STA an authentication denial if the STA is outside the threshold distance. A STA that is issued an authentication grant may be authorized to receive services from the AP or another device associated with the authentication. A STA that is issued an authentication denial may be denied authorization to receive services from the AP or another device associated with the authentication. In some cases, the AP may send to the STA an indication of the sensed proximity and/or authorization status of the STA.

An apparatus for wireless communication is described. The apparatus may include a memory that stores instructions and a processor coupled with the memory. The processor and memory may be configured to receive a reference waveform, determine spectral characteristics for the reference waveform, transmit, to an access point, a report including the determined spectral characteristics, and receive, from the access point and in response to the transmitted report, an indication of a sensed proximity between the access point and the station.

Another apparatus for wireless communication is described. The apparatus may include means for receiving a reference waveform, means for determining spectral characteristics for the reference waveform, means for transmitting, to an access point, a report including the determined spectral characteristics, and means for receiving, from the access point and in response to the transmitted report, an indication of a sensed proximity between the access point and the station.

A method of wireless communication is described. The method may include receiving a reference waveform, determining spectral characteristics for the reference waveform, transmitting, to an access point, a report including the determined spectral characteristics, and receiving, from the access point and in response to the transmitted report, an indication of a sensed proximity between the access point and the station.

A non-transitory computer readable medium is described. The non-transitory computer-readable medium may include code for wireless communication. The code may include instructions executable to receive a reference waveform, determine spectral characteristics for the reference waveform, transmit, to an access point, a report including the determined spectral characteristics, and receive, from the access point and in response to the transmitted report, an indication of a sensed proximity between the access point and the station.

In some examples of the method, apparatus, or non-transitory computer-readable medium described above, the reference waveform may be received from the access point. In some examples of the method, apparatus, or non-transitory computer-readable medium described above, the received indication of the sensed proximity comprises at least a proximity report, or an authentication grant, or an authentication denial, or a combination thereof. Some examples of the method, apparatus, or non-transitory computer-readable medium described above may further include processes, features, means, or instructions for connecting to the access point based at least in part on the received indication of the sensed proximity.

Some examples of the method, apparatus, or non-transitory computer-readable medium described above may further include processes, features, means, or instructions for exchanging, with the access point, at least measurement capabilities, or configuration parameters for determining the spectral characteristics, or a combination thereof. In some examples of the method, apparatus, or non-transitory computer-readable medium described above, the reference waveform may be a pseudo-random signal unknown to the station. In some examples of the method, apparatus, or non-transitory computer-readable medium described above, the determined spectral characteristics for the reference waveform include at least a received signal strength indicator (RSSI), or a fast fourier transform (FFT) bin, or a peak magnitude, or a frequency, or a signal level, or a noise floor, or a combination thereof. In some examples, the apparatus is a wireless communication terminal and includes an antenna and a transceiver.

An apparatus for wireless communication is described. The apparatus may include a memory that stores instructions and a processor coupled with the memory. The processor and memory may be configured to receive a reference waveform at the access point, determine spectral characteristics for the received reference waveform, receive, from a station, a report of spectral characteristics for the reference waveform as received at the station, and sense a proximity of the station to the access point based at least in part on a comparison of the determined spectral characteristics for the received reference waveform and the spectral characteristics for the reference waveform as received at the station.

Another apparatus for wireless communication is described. The apparatus may include means for receiving a reference waveform at the access point, means for determining spectral characteristics for the received reference waveform, means for receiving, from a station, a report of spectral characteristics for the reference waveform as received at the station, and means for sensing a proximity of the station to the access point based at least in part on a comparison of the determined spectral characteristics for the received reference waveform and the spectral characteristics for the reference waveform as received at the station.

A method of wireless communication is described. The method may include receiving a reference waveform at an access point, determining spectral characteristics for the received reference waveform, receiving, from a station, a report of spectral characteristics for the reference waveform as received at the station, and sensing a proximity of the station to the access point based at least in part on a comparison of the determined spectral characteristics for the received reference waveform and the spectral characteristics for the reference waveform as received at the station.

A non-transitory computer readable medium is described. The non-transitory computer-readable medium may store code for wireless communication. The code may include instructions executable to receive a reference waveform at an access point, determine spectral characteristics for the received reference waveform, receive, from a station, a report of spectral characteristics for the reference waveform as received at the station, and sense a proximity of the station to the access point based at least in part on a comparison of the determined spectral characteristics for the received reference waveform and the spectral characteristics for the reference waveform as received at the station.

Some examples of the method, apparatus, or non-transitory computer-readable medium described above may further include processes, features, means, or instructions for transmitting, to the station, an indication of the sensed proximity. Some examples of the method, apparatus, or non-transitory computer-readable medium described above may further include processes, features, means, or instructions for transmitting the reference waveform by the access point, wherein the access point receives the transmitted reference waveform. In some examples of the method, apparatus, or non-transitory computer-readable medium described above, the comparison comprises: correlating the determined spectral characteristics for the reference waveform with the spectral characteristics for the reference waveform as received at the station.

In some examples of the method, apparatus, or non-transitory computer-readable medium described above, correlating includes constructing a first spectrogram based at least in part on the determined spectral characteristics. Some examples of the method, apparatus, or non-transitory computer-readable medium described above may further include processes, features, means, or instructions for determining a correlation value from a correlation between the first spectrogram and a second spectrogram constructed based at least in part on the spectral characteristics for the reference waveform as received at the station, wherein sensing the proximity of the station to the access point may be based at least in part on the determined correlation value.

Some examples of the method, apparatus, or non-transitory computer-readable medium described above may further include processes, features, means, or instructions for determining that the sensed proximity satisfies a predetermined threshold. Some examples of the method, apparatus, or non-transitory computer-readable medium described above may further include processes, features, means, or instructions for allowing a connection with the station based at least in part on the determination that the sensed proximity satisfies the predetermined threshold.

Some examples of the method, apparatus, or non-transitory computer-readable medium described above may further include processes, features, means, or instructions for determining that the sensed proximity fails to satisfy a predetermined threshold. Some examples of the method, apparatus, or non-transitory computer-readable medium described above may further include processes, features, means, or instructions for refraining from allowing a connection with the station based at least in part on the determination that the sensed proximity does not satisfy the predetermined threshold.

Some examples of the method, apparatus, or non-transitory computer-readable medium described above may further include processes, features, means, or instructions for exchanging, with the station, at least measurement capabilities, or configuration parameters for determining the spectral characteristics, or a combination thereof. In some examples of the method, apparatus, or non-transitory computer-readable medium described above, the reference waveform may be a pseudo-random signal known to the access point and unknown to the station. In some examples, the apparatus is an access point and includes an antenna and a transceiver. In some examples, the access point includes an auxiliary transmitter to transmit the reference waveform.

### BRIEF DESCRIPTION OF THE DRAWINGS

FIG. 1 illustrates a wireless communications system that supports proximity sensing using spectral analysis in accordance with aspects of the present disclosure.

FIG. 2 illustrates an example of a wireless communications system that supports proximity sensing using spectral analysis in accordance with aspects of the present disclosure.

FIG. 3 illustrates an example of a wireless communications system that supports proximity sensing using spectral analysis in accordance with aspects of the present disclosure.

FIG. 4 illustrates an example of a process flow for proximity sensing using spectral analysis in accordance with aspects of the present disclosure.

FIG. 5 illustrates an example of a flow diagram for proximity sensing using spectral analysis in accordance with aspects of the present disclosure.

FIG. 6 illustrates an example of a flow diagram for proximity sensing using spectral analysis in accordance with aspects of the present disclosure.

FIG. 7 shows a block diagram of a wireless device that supports proximity sensing using spectral analysis in accordance with aspects of the present disclosure.

FIG. 8 shows a block diagram of a wireless device that supports proximity sensing using spectral analysis in accordance with aspects of the present disclosure.

FIG. 9 shows a block diagram of a proximity sensing manager that supports proximity sensing using spectral analysis in accordance with aspects of the present disclosure.

FIG. 10 illustrates a block diagram of a system including a station that supports proximity sensing using spectral analysis in accordance with aspects of the present disclosure.

FIG. 11 shows a block diagram of a wireless device that supports proximity sensing using spectral analysis in accordance with aspects of the present disclosure.

FIG. 12 shows a block diagram of a wireless device that supports proximity sensing using spectral analysis in accordance with aspects of the present disclosure.

FIG. 13 shows a block diagram of a proximity sensing manager that supports proximity sensing using spectral analysis in accordance with aspects of the present disclosure.

FIG. 14 illustrates a block diagram of a system including an access point that supports proximity sensing using spectral analysis in accordance with aspects of the present disclosure.

FIGS. 15 through 18 show flowcharts illustrating methods for proximity sensing using spectral analysis in accordance with aspects of the present disclosure.

### DETAILED DESCRIPTION

An access point (AP) may authenticate a client device, such as a station (STA), by sensing the proximity of the STA relative to the AP using spectral analysis. For example, a STA may be configured (e.g., by the AP) to sense a reference waveform sent over a wireless channel in the same manner as the AP. By comparing the respective channel conditions sensed by the STA and the AP, the AP may determine the proximity of the STA. The AP may authenticate the STA if the STA is within a predetermined range of the AP, which may be referred to as the area of relevance. Alternatively, the AP may deny authentication of the STA if the STA is outside the area of relevance. The AP may provide authentication on behalf of itself or on behalf of third party devices. An authentication grant may permit the STA to access services provided by the AP or other devices associated with the authentication. An authentication denial may preclude the STA from accessing services provided by the AP or other devices associated with the authentication. By determining proximity information for the STA as described further herein, the AP may provide higher-quality service by limiting authorized connections to proximate STAs, and better control access to services provided by the AP, or other wireless devices in a network associated with the AP.

In some examples, the reference waveform may be a pseudorandom signal sent by the AP (e.g., via an auxiliary transmitter of the AP, or coupled to the AP). Alternatively, the reference waveform may be sent by a third party device that is in communication with the AP. The AP and STA may sense the channel conditions by determining spectral characteristics for the reference waveform. For example, the AP and STA may perform spectral measurements and analysis on the reference waveform to determine aspects and features of the reference waveform and/or channel such as signal strength (e.g., as represented by received signal strength indicator (RSSI)), fast Fourier transform (FFT) magnitude, frequency, signal level, noise floor, etc.). In some cases, the spectral characteristics may be determined by extraction from a spectrogram that is constructed based on the reference waveform. The spectrogram may be a visual representation of the magnitude of the received reference waveform versus frequency (e.g., FFT bin).

The AP may receive a report of the spectral characteristics determined by the STA. The report may convey the spectral characteristics directly, as individual features, or indirectly, in a spectrogram. The AP may correlate the spectral characteristics from the STA and the spectral characteristics determined by the AP. In some cases, the AP may correlate a spectrogram from the STA and a spectrogram constructed by the AP. If the spectral characteristics are strongly correlated (e.g., a correlation value exceeds a first predetermined threshold), then the AP may determine that the STA is experiencing similar channel conditions as that of the AP and that the STA is within close proximity (e.g., the STA is within the area of relevance relative to the AP). If the spectral characteristics are weakly correlated (e.g., a correlation value is below a second predetermined threshold, which may be the same or different than the first predetermined threshold), the AP may determine that the STA is experiencing channel conditions different from those experienced by the AP and that the STA is not within close proximity (e.g., the STA is outside the area of relevance for the AP). Thus, the AP may authenticate, or deny authentication for, the STA based on the sensed proximity of the STA.

In some cases, the AP may coordinate the measurement procedure used by the AP and the STA so that the measurements are synchronized and performed in the same manner. The AP may take the hardware and software capabilities of the AP and the STA into account when coordinating the measurement procedure. For example, the AP and STA may communicate their respective measurement capabilities (e.g., as limited by their hardware and software revisions) prior to performing measurements on the reference waveform. The AP may select measurement parameters (e.g., timing, bandwidth, number of samples, etc.) so that the STA and the AP are each capable of performing the same measurements.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Aspects of the disclosure are initially described in the context of a wireless communications system. Aspects of the disclosure are further illustrated by and described with reference to apparatus diagrams, system diagrams, and flowcharts that relate to proximity sensing using spectral analysis

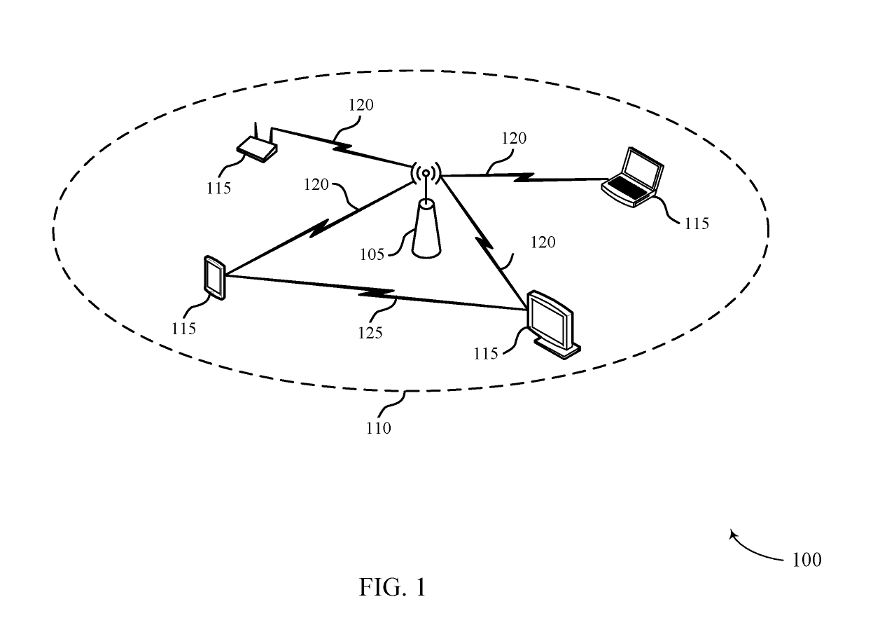

FIG. 1 illustrates a wireless communications system 100 configured in accordance with various aspects of the present disclosure. The wireless communications system 100 may be an example of a wireless local area network (WLAN) (also known as a Wi-Fi network, such as 802.11ax) and may include an access point (AP) 105 and multiple associated stations (STAs) 115. Devices in wireless communications system 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The STAs 115 may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc.

The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the wireless communications system 100. An extended network station associated with the wireless communications system 100 may be connected to a wired or wireless distribution system that may allow multiple APs 105 to be connected in an ESS. Prior to providing services to a STA 115, the AP 105 may authenticate the STA 115 (e.g., verify that the STA 115 is allowed to be serviced by the AP 105). In some cases, the AP 105 may also be responsible for authenticating the STAs 115 for other devices. For example, the AP 105 may be trusted by the network, or other devices capable of providing connectivity or services, to authenticate STAs 115 that are requesting connection to, and/or services from, said entities.

In some cases, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

An AP 105 may communicate with a STA 115 via uplink and downlink. Uplink transmissions may refer to transmissions from the STA 115 to the AP 105 and downlink transmissions may refer to transmissions from the AP 105 to the STA 115. A number of communication techniques may be used for downlink (DL) and uplink (UL) transmissions. For example, a wireless device (e.g., an AP 105) may implement beamforming in which the energy of a transmission is focused in a particular direction (e.g., towards a STA 115, or a set of STAs 115). In some cases, single-input-single-output (SISO) techniques may be used for communications between an AP 105 and STA 115 in which both the AP 105 and the STA 115 use a single antenna. In other cases, multiple-input-multiple-output (MIMO) techniques may be used for when the AP 105 and/or STA 115 involved in a communication include multiple antennas.

In some cases, uplink and/or downlink multi-user MIMO (MU-MIMO) may be used. For example, uplink/downlink single-user MIMO (SU-MIMO) may be used in which multiple streams of data are simultaneously communicated (e.g., from an AP 105 to a STA 115) using multiple antennas and beamforming technology. In multi-user MIMO (MU-MIMO), for example downlink MU-MIMO, an AP 105 may simultaneously send multiple streams to multiple STAs 115 by taking advantage of spatial diversity in transmission resources and multiple antennas.

In some cases, an AP 105 may be associated with an area of relevance. An area of relevance may be the area in which a device, such as an AP 105, provides service. An area of relevance may differ from a coverage area 110 in the AP 105 may be capable of providing service to client devices outside the area of relevance, but may determine not to provide service. Also, the area of relevance may be variable (e.g., the AP 105 may dynamically modify its area of relevance based on communication and/or environmental factors). An AP 105 may implement an area of relevance to aid in the authentication of client devices. For example, an AP 105 may authenticate client devices that are within the area of relevance and deny authentication of client devices that are outside the area of relevance. Authentication may refer to the process of determining whether a client device is a candidate for service—a client device that is issued an authentication grant may be provided service by the AP 105 and a client device that is issued an authentication denial may be denied service from the AP 105. Thus, the AP 105 may control which client devices are serviced based on the proximity of the client devices to the AP 105. Such an ability may be useful for an AP 105 that provides intranet access (e.g., for a company) or for an AP 105 that provides Wi-Fi (e.g., for a coffee shop) by allowing the AP 105 to prevent unauthorized client devices from taking advantage of services provided by the AP 105 (e.g., a client device located in a the building of a competitor that is next door or used by a person who is not a patron). The techniques described herein may also mitigate hacking of IoT devices. In some cases, the AP 105 may perform authentication on behalf of a third party (e.g., another device or the network). For instance, the AP 105 may be trusted by the third party to ascertain whether or not the third party should provide services to a client device. In such cases, the AP 105 may pass authentication information (e.g., regarding authentication grants and denials) for clients devices to the third party.

In some cases, a STA 115 and/or AP 105 may be unaware when the STA 115 is located in an area of relevance. For example, the STA 115 and/or AP 105 may not support geo-location protocols such as global positioning system (GPS), near field communications (NFC), or other protocols or techniques that may help determine proximity information for the device. For example, a STA 115 may be a low-cost device in the internet of things (IoT) (e.g., a sensor, meter, etc.) and may be capable of communication via Wi-Fi but may lack location-based capabilities. In another example, the AP 105 may be a device capable of financial transactions, such as a point-of-sale (PoS) terminal. A STA 115 that does not support geo-location protocols may be unaware when it is located in an area of relevance. Lack of proximity information may result in the STA 115 attempting to connect to an AP 105 that is too far away to provide quality service, or to an AP 105 that is not allowed to provide service. A lack of proximity information at an AP 105 may result in the AP providing service to a client device that is outside the area of relevance. An AP 105 may implement the proximity sensing techniques described herein to determine the proximity of client device and perform authentication of the client device.

For example, an AP 105 may transmit a reference waveform that is received by a client device (e.g., a STA 115) and the AP 105. The AP 105 may perform spectral analysis on the received waveform to determine spectral characteristics of the waveform. The spectral characteristics may be indicative of the wireless channel over which the reference waveform was received. In some cases, the spectral characteristics are derived from a spectrogram of the reference waveform (e.g., a visual representation of the signal over time or frequency). The AP 105 may receive, from the STA 115, spectral characteristics for the reference waveform as received at the STA 115. The AP 105 may compare the spectral characteristics from the STA 115 to the spectral characteristics determined by the AP 105. In some examples, the AP 105 may correlate the spectral characteristics. If the spectral characteristics are the same or sufficiently the same (e.g., within a predetermined threshold difference), the AP 105 may determine that the STA 115 is experiencing channel conditions similar to those experienced by the AP 105 and that the STA 115 is within close proximity (e.g., within a threshold distance, such as the area of relevance). If the spectral characteristics are sufficiently different (e.g., outside a predetermined threshold difference), the AP 105 may determine that the STA 115 is experiencing channel conditions different from those experienced by the AP 105 and that the STA 115 is not within close proximity (e.g., the STA 115 is outside the area of relevance). Based on the sense proximity, the AP 105 may authenticate the STA 115. For example, the AP 105 may issue the STA 115 an authentication grant if the STA 115 is within the area of relevance and the AP 105 may issue an authentication denial if the STA 115 is outside the area of relevance.

Although described with reference to a reference waveform, the techniques described herein may be performed using measurements and spectral characteristics of any waveform received by both the device responsible for authentication and the device being authenticated. The use of a waveform that is not a reference waveform may conserve power by the authentication device and may be suitable when the area of relevance is small. Although described with reference to authentication, the proximity sensing and spectral analysis techniques described herein may be employed for other processes and procedures.

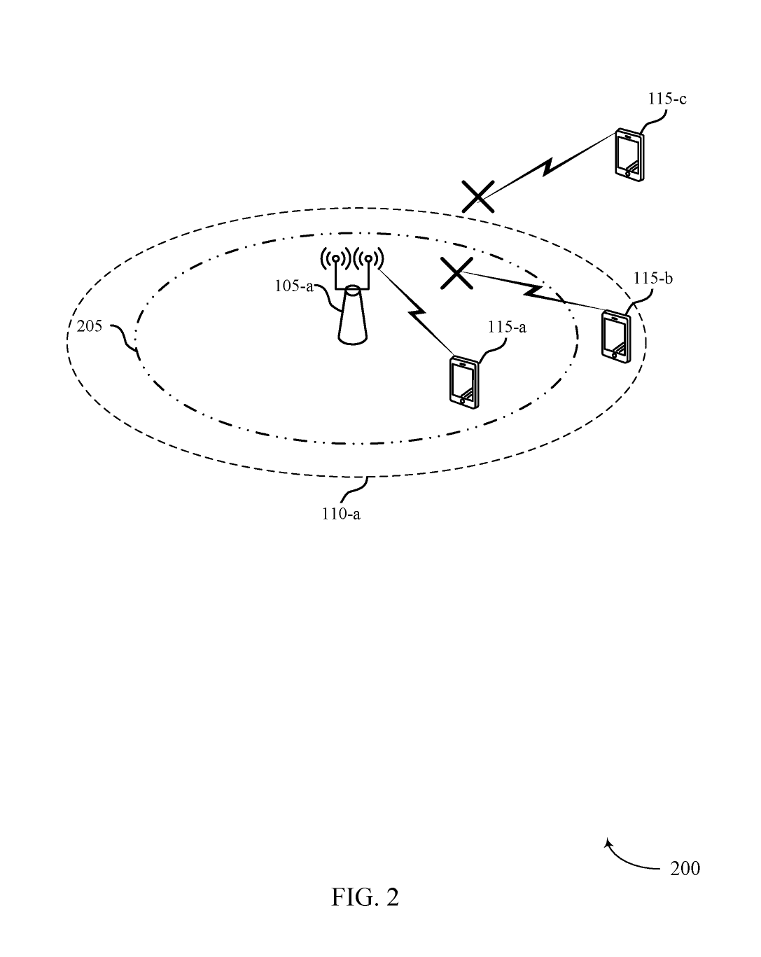

FIG. 2 illustrates an example of a wireless communications system 200 that supports proximity sensing using spectral analysis. Wireless communications system 200 may include AP 105-a, STA 115-a, STA 115-b, and STA 115-c, which may be examples of the corresponding devices described with reference to FIG. 1. AP 105-a, STA 115-a, STA 115-b, and STA 115-c may be part of the same BSS. AP 105-a may be capable of communicating with wireless devices inside coverage area 110-a; for example, AP 105-a may be capable of communicating with STA 115-a and STA 115-b over a wireless channel. In some cases, AP 105-a may restrict communications to wireless devices within close proximity to AP 105-a. For example, AP 105-a may establish an area of relevance 205 outside of which AP 105-a refuses to service client devices. AP 105-a may determine whether a client device is within the area of relevance 205 using the proximity sensing techniques described herein.

AP 105-a may sense the proximity of client devices by transmitting a reference waveform that is received by client devices and AP 105-a. Each device that receives the reference waveform may perform spectral analysis on the reference waveform to determine spectral characteristics of the reference waveform. The spectral characteristics may be indicative of the conditions of the channel used to convey the reference waveform. AP 105-a may receive a report of spectral characteristics from a client device and compare the received spectral characteristics to the spectral characteristics determined by AP 105-a. If the results of the comparison reveal that the spectral characteristics are different by a threshold amount, AP 105-a may determine that the client device is far from AP 105-a. If the results of the comparison reveal that the spectral characteristics are the same or nearly the same (e.g., the differences are less than a threshold amount), AP 105-a may determine that the client device is close to AP 105-a. Using this information, AP 105-a may authenticate a client device based on the proximity of the client device to AP 105-a.

For example, using the above-described sensing process, AP 105-a may sense that STA 115-a is outside of coverage area 110-a, that STA 115-b is inside of coverage area 110-a but outside of the area of relevance 205, and that STA 115-a is inside the area of relevance 205. Based on the sensed proximities, AP 105-a may authenticate STA 115-a and deny authentication of STA 115-b and STA 115-c. For instance, AP 105-a may allow a connection to STA 115-a and refrain a connection with STA 115-b and STA 115-c (e.g., AP 105-a may refrain from initiating a connection with STA 115-b and STA 115-c, or deny (e.g., ignore) a connection attempt from STA 115-b and STA 115-c).

AP 105-a may determine the area of relevance 205 based on various parameters such as channel conditions, time of day, number of client devices (STAs) within coverage area 110-a, etc. For example, AP 105-a may select an area of relevance 205 that overlaps coverage 110-a when there are few client devices within coverage area 110-a. When the number of client devices exceeds a predetermined threshold, AP 105-a may reduce the area of relevance 205 so that it is smaller than coverage area 110-a. The degree of reduction may be related to the number of client devices within coverage area 110-a. AP 105-a may implement the selected area of relevance 205 by varying the transmit power used to transmit the reference waveform.

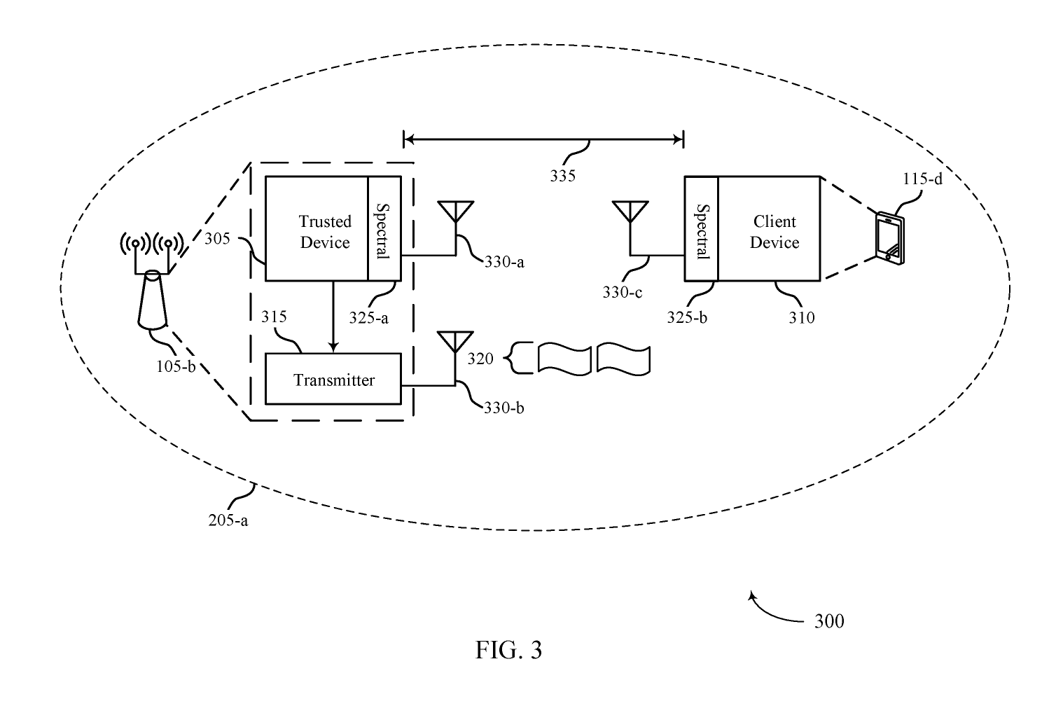

FIG. 3 illustrates an example of a wireless communications system 300 that supports proximity sensing using spectral analysis. Wireless communications system 300 may include a trusted device 305 and a client device 310. Trusted device 305 may be an example of an AP 105, or a portion or component of an AP 105, such as that described with reference to FIGS. 1 and 2 (e.g., trusted device 305 may be AP 105-b), or trusted device 305 may be another device trusted by the network and capable of providing one or more services via wireless communications (e.g., a point of sale (PoS) terminal). Trusted device 305 may provide connectivity and/or services to client devices within area of relevance 205-a. Client device 310 may be example of a STA 115, or a portion or component of an AP 105, such as that described with reference to FIGS. 1 and 2 (e.g., client device may be STA 115-d), or client device 310 may be an example of another device capable of wireless communications (e.g., an IoT device). In some cases, client device 310 may not support geo-location protocols. According to the techniques described herein, the trusted device 305 may determine the proximity of the client device 310 based on an analysis of spectral characteristics of a reference waveform. The trusted device 305 may determine whether to provide service to the client device 310 based on the proximity of the client device 310.

The trusted device 305 and the client device 310 may each include spectral components 325 (e.g., trusted device 305 may include spectral components 325-a and client device 310 may include spectral components 325-b). A spectral component 325 may include hardware and software responsible for making measurements on, and deriving spectral characteristics from, received signals. A spectral component 325 may be coupled with one or more antennas (e.g., spectral component 325-b may be coupled with antenna 330-c). Trusted device 305 may include multiple radios, transceivers, receives, transmitters, antennas, and or transmit/receive chains. In one example, trusted device 305 may include an auxiliary transmitter, such as transmitter 315 (e.g., transmitter 315 may be part of the trusted device 305. Alternatively, the transmitter 315 may be part of a different wireless device, for example coupled to trusted device 305. The transmitter 315 may be coupled with one or more antennas (e.g., antenna 330-b) that are capable of independent operation with respect to other antennas (e.g., antenna 330-a, which is coupled with spectral components 325-a). Thus, a signal that is transmitted by the trusted device 305 (e.g., via transmitter 315 and antenna 330-b) may also be received by the trusted device 305 (e.g., via antenna 330-a).

The transmitter 315 may transmit a reference waveform 320. The reference waveform 320 may be a pseudo-random signal (e.g., a random signal at a random frequency, or an output of a pseudo-random number generator). The reference waveform 320 may be randomized periodically to protect against replication. If the transmitter 315 is part of trusted device 305 then the reference waveform 320 may be known to the trusted device 305. The reference waveform 320 may be received by devices within range of the transmitter 315. Thus, trusted device 305 and client device 310 may both receive reference waveform 320. In one example, the reference waveform 320 may be received by devices within the area of relevance 205-a, but not necessarily devices within the coverage area of the trusted device 305.

The trusted device 305 and the client device 310 may each perform measurements on the reference waveform 320 (e.g., using spectral components 325). For example, the devices may determine or capture aspects of the reference waveform 320 such as signal strength (e.g., in the form of received strength signal indicator (RSSI)), frequency, noise floor, signal peak, etc. In some cases, the measurements may be synchronized between the trusted device 305 and the client device 310. For example, the trusted device 305 and the client device 310 may exchange capabilities (e.g., hardware capabilities and/or software capabilities, or other capabilities that limit the ability of the devices to make measurements). Based on the exchange of capabilities, the devices may select parameters for the measurements that accommodate the abilities of both devices. Thus, the trusted device 305 and the client device 310 may simultaneously make the same types of spectral measurements across the same bandwidths using the same parameters. Such synchronization or matching may ensure that differences between spectral characteristics of the reference waveform 320 that arise from later comparisons are indicative of different channel conditions and not the result of heterogeneous measurements.

In some cases, one or both of the trusted device 305 and the client device 310 may construct a spectrogram (e.g., a visual representation of the spectral measurements over time) of the reference waveform 320. In one example, the spectrogram may include the magnitude of a signal across frequency bins. The trusted device 305 and the client device 310 may determine spectral characteristics for the reference waveform 320 by extracting the spectral characteristics from their respective spectrograms. Alternatively, the trusted device 305 and the client device 310 may forego construction of a spectrogram and may determine the spectral characteristics for the reference waveform 320 directly from the measurements of the reference waveform 320.

After the client device 310 determines spectral characteristics for the reference waveform 320, the client device 310 may send some or all of the spectral characteristics to the trusted device in a spectral report. The spectral report may convey the spectral characteristics directly (e.g., via explicit indication of the spectral characteristics) or indirectly (e.g., in a spectrogram). The client device 310 may send spectral reports periodically or based on a trigger (e.g., a request from the trusted device 305). The trusted device 305 may receive the spectral characteristics from the client device 310 in the spectral report and compare the received spectral characteristics to the spectral characteristics determined by client device 310. In one example, the trusted device 305 may compute a correlation between the spectral characteristics. The correlation may be a correlation coefficient such as the Pearson product-moment correlation coefficient between the spectral characteristics measured across a number of frequencies or frequency bins. For example, the trusted device 305 may compute a correlation between a spectrogram of the reference waveform 320 as received by the trusted device 305 and a spectrogram of the reference waveform 320 as received by the client device 310. The spectrogram of the reference waveform 320 as received from the client device may be received directly from the client device 310 (e.g., in a spectral report) or indirectly (e.g., the spectrogram may be constructed from spectral characteristics conveyed in the spectral report).

If the spectral characteristics are strongly correlated (e.g., the value resulting from the correlation satisfies a predetermined threshold), the trusted device 305 may determine that the reference waveform 320 was received by the trusted device 305 and the client device 310 under similar channel conditions and that the client device 310 is within close proximity to the trusted device 305. In such cases, the trusted device 305 may authenticate the client device 310 (e.g., the trusted device may allow establishment of a connection, or initiate a connection, to the client device 310). Such authentication may mitigate the hacking of IoT devices. In some cases, authentication may involve the trusted device 305 allowing a transaction (e.g., a financial transaction) to occur between the client device 310 and the trusted device 305. Thus, the trusted device 305 may perform authentication of client device 310 based on the proximity of client device 310.

If the spectral characteristics are weakly correlated (e.g., the value resulting from the correlation does not satisfy a predetermined threshold), the trusted device 305 may determine that the reference waveform 320 was received by the trusted device 305 and the client device 310 under different channel conditions and that the client device 310 is not within close proximity. In such cases, the trusted device 305 may refrain from authenticating the client device 310 (e.g., the trusted device 305 may not allow establishment of a connection, or initiate a connection, to the client device 310, or the trusted device 305 may not allow certain transactions with the client device 310).

The correlation value may be used by the trusted device 305 to determine whether the client device 310 is in an acceptable proximity or range for authentication without determining the actual distance of the client device 310. For example, the trusted device 305 may select a threshold correlation value of x that is associated with the area of relevance 205-a. Devices within the area of relevance may be within a range for authentication and devices outside the authentication perimeter may be outside a range for authentication. The trusted device 305 may compare the computed correlation value with the threshold correlation value x. If the computed correlation value is greater than the threshold value, then the trusted device 305 may determine that the client device 310 is within an acceptable range for authentication (e.g., within the area of relevance 205-a). If the computed correlation value is less than the threshold value, then the trusted device 305 may determine that the client device 310 is outside of the acceptable range for authentication (e.g., outside the area of relevance). In some cases, correlation value may be used to determine or estimate the distance 335 of the client device 310 from the trusted device 305. For example, the trusted device 305 may associated different correlation values with different distances. The trusted device 305 may estimate the distance 335 to client device 310 by matching the computed correlation value with one of the correlation values indicative of distance. Regardless of which technique is used, the trusted device 305 may sense the proximity of the client device 310 based on the comparison (e.g., correlation) of spectral characteristics.

In some cases, the trusted device 305 may send to the client device 310 an indication of the sensed proximity of the client device 310. The indication of sensed proximity may include a proximity of the client device 310 to the trusted device 305 (e.g., the indication may be a proximity report). Additionally or alternatively, the indication of sensed proximity may be conveyed by or include the authentication status of the client device 310 (e.g., whether or not the client device 310 has been authenticated by the trusted device 305). For instance, the indication may include an authentication grant if the client device 310 is authenticated or an authentication denial if the client device 310 is denied authentication. The client device 310 may communicate, or refrain from communicating, with the trusted device 305 based on the content of the indication of sensed proximity.

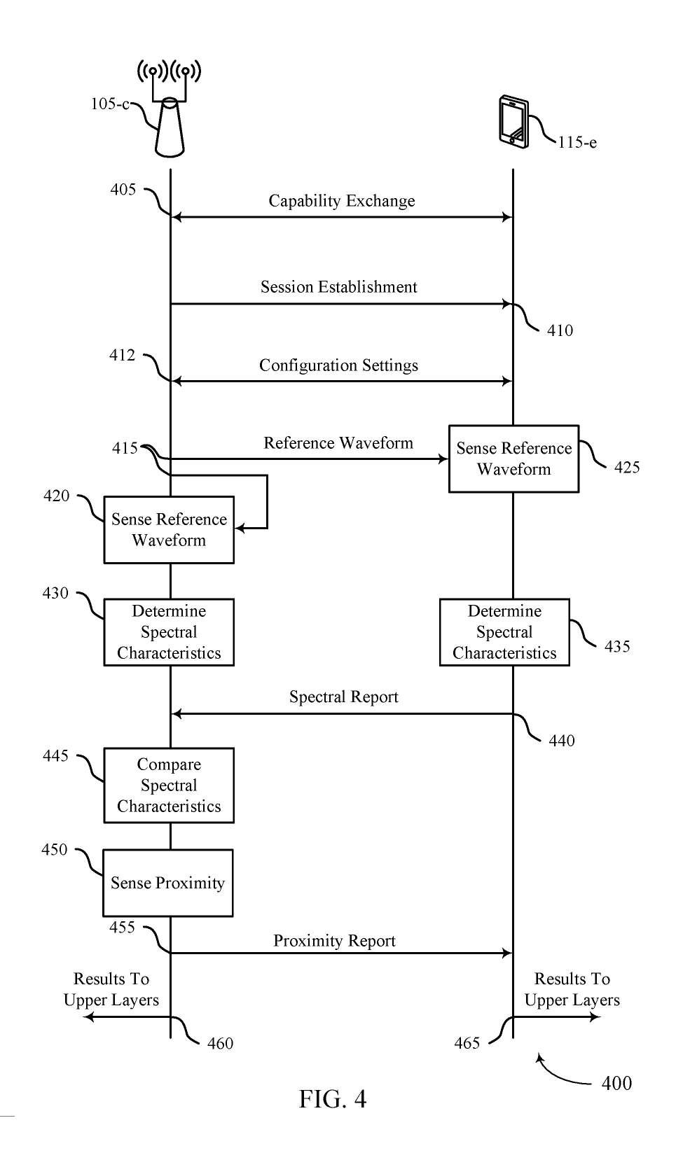

FIG. 4 illustrates an example of a process flow 400 for proximity sensing using spectral analysis. Process flow 400 may represent aspects of techniques performed by an AP 105 and a STA 115 as described with reference to FIGS. 1-3. Process flow 400 may include AP 105-c, which may be an example of a trusted device 305 as described with reference to FIG. 3. AP 105-c may be associated with a coverage area and an area of relevance. Process flow 400 may also include STA 115-e, which may be an example of a client device 310 described with reference to FIG. 3. AP 105-c may include multiple transmitters, including an auxiliary transmitter that transmits a reference waveform such as described with reference to FIG. 3. AP 105-c and STA 115-e may both be capable of performing spectral analysis on received signals, including the reference waveform transmitted by the auxiliary transmitter.

At 405, AP 105-c and STA 115-e may perform a measurement capability exchange in which AP 105-c and STA 115-e communicate their respective measurement capabilities to one another. For example, AP 105-c and STA 115-e may indicate their respective hardware revision and software revision. The capability exchange may also indicate the maximum spectral capability supported by AP 105-c and STA 115-e, and/or the spectral configuration profile supported by AP 105-c and STA 115-e (e.g., the various spectral parameter configurations supported by AP 105-c and STA 115-e). AP 105-c may analyze the capabilities of both devices and select hardware and software settings that are supported by both devices. At 410, AP 105-c may send a session establishment signal to STA 115-e. The session establishment signal may include information for setting up a spectral analysis session (e.g., a session in which spectral analysis is performed on a reference waveform). For example, the session establishment signal may include information indicating the spectral profile (e.g., the frequency bin and timing parameters of the spectral analysis) to be used by both devices. At 412, AP 105-c and STA 115-e may exchange configuration settings for proximity sensing. The configuration settings may include spectral analysis parameters such as FFT size, spectral count spectral period, etc.

Thus, AP 105-c and STA 115-e may perform synchronized or matching spectral measurements and analysis on a reference waveform based on the capability information, session establishment information, and configuration setting information exchanged between AP 105-c and STA 115-e. In some examples, the exchanges between AP 105-a and STA 115-e may be encrypted for security.

At 415, AP 105-c may transmit a reference waveform. The reference waveform may be received by AP 105-c and STA 115-e. At 420, AP 105-c may sense the reference waveform and perform spectral measurements on the reference waveform. At 425, STA 115-e may sense the reference waveform and perform spectral measurements on the reference waveform. AP 105-c may determine spectral characteristics for the reference waveform at 430 and STA 115-e may determine spectral characteristics for the reference waveform at 435. The spectral characteristics may include RSSI, FFT magnitude, frequency, signal level, noise floor, etc. In some cases, one or both of AP 105-c and STA 115-e may construct a spectrogram of the reference waveform. At 440, STA 115-e may send a spectral report to AP 105-c that includes the spectral characteristics (e.g., FFT reports based on the configured profile) for the reference waveform. In some cases, the spectral characteristics are conveyed in a spectrogram. The proximity report may include spectral meta data (e.g., when the spectral characteristics were measured, across what frequencies, etc.).

At 445, AP 105-c may perform a comparison of the spectral characteristics. For example, AP 105-c may correlate the spectral characteristics received in the spectral report and the spectral characteristics determine by AP 105-c. AP 105-c may sense the proximity of STA 115-e based on the results of the comparison. For example, AP 105-c may compare a correlation value resulting from the correlation to a predetermined threshold value. If the correlation value satisfies the predetermined threshold value, AP 105-c may determine that STA 115-e is within the area of relevance of AP 105-c and may authenticate STA 115-e. If the correlation value fails to satisfy the predetermined threshold value, AP 105-c may determine that STA 115-e is outside the area of relevance of AP 105-c and deny authentication of STA 115-e. At 455, AP 105-c may send, and STA 115-e may receive, a proximity report. The proximity report may include an indication of the sensed proximity of STA 115-e and/or an authentication status of STA 115-e. At 460, AP 105-c may report the results of the comparison, proximity, and/or authentication to upper layers (e.g., software upper layers such as application layers) of AP 105-c. At 465, STA 115-e may report the results of the sensed proximity and/or authentication to upper layers (e.g., software upper layers such as application layers) of STA 115-e. The upper layers of AP 105-c and/or STA 115-e may use the comparison, proximity, and/or authentication information to control communications (e.g., connection establishment, service provision, transaction allowance, etc.). In some cases, the authentication status of STA 115-e may be passed to other entities associated with the authentication (e.g., entities on behalf of which the AP is performing the authentication).

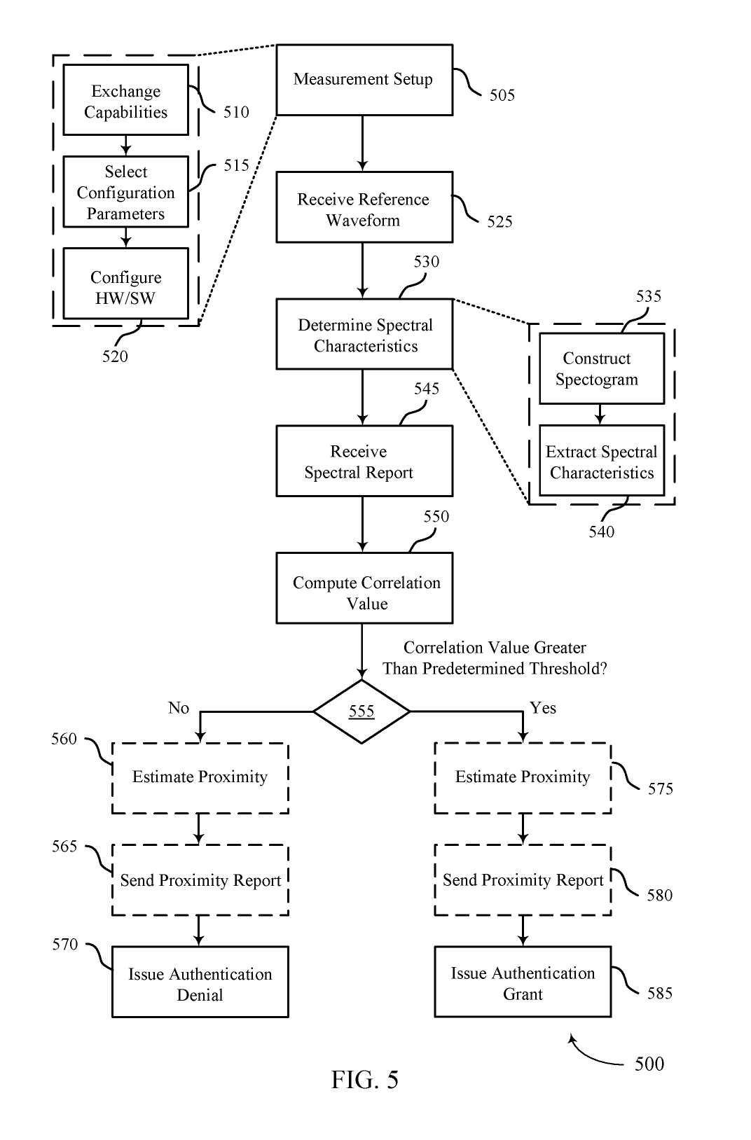

FIG. 5 illustrates an example of a flow diagram 500 for proximity sensing using spectral analysis. Flow diagram 500 may be an example of actions of an AP 105 such as described with reference to FIGS. 1-4. The AP 105 may be an example of a device trusted by a network and/or other devices or applications and may be associated with an area of relevance. The AP 105 may include multiple transmitters, including auxiliary transmitter that is capable of transmitting a reference waveform such as described herein. The AP 105 may use one or more transmitters other than the auxiliary transmitter to send data and control message to client devices such as a STA 115.

At 505, the AP 105 may perform a measurement setup with a STA 115. The measurement setup may establish parameters and rules for performing spectral measurements on a reference waveform. Thus, the AP 105 and STA 115 may perform the same type of measurements across the same bandwidth and in some cases at the same time. In some cases, setting up the measurement parameters may include exchanging measurement capabilities and limitations between the AP 105 and the STA 115 at 510. The measurement capabilities may be communicated between the AP 105 and the STA 115 using broadcast or unicast frames. In one example, the AP 105 may learn about the capabilities of the STA 115 and the STA 115 may learn about the capabilities of the AP. In another example, only the AP 105 may learn about the capabilities of STA 115 (e.g., to conserve power at the STA 115).

In some cases, setting up the measurement parameters may include selecting configuration parameters at 515. Configuration parameters, which may also be referred to herein as session parameters, may identify timing and frequency aspects of the spectral measurements that are to be performed during a spectral measurement session. Configuration parameters may include parameters such as measurement timing (e.g., when to start and stop spectral measurements), measurement bandwidth (e.g., the bandwidth over which measurements are to be performed), measurement sample size (e.g., how many measurements to take during the measurement period), FFT bin size, spectral count (e.g., the number of FFT bins), spectral period, etc. The configuration parameters may be based on the measurement capabilities of the AP 105 and the STA 115. At 520, the AP 105 may select hardware (HW) and software (SW) configure settings. The AP 105 may select the HW/SW configuration settings based on the capabilities of the AP 105 and the STA 115, and/or on the configuration parameters. Alternatively, the configuration parameters may be based on the HW/SW configuration settings. The AP 105 may indicate the HW/SW configuration settings to the STA 115.

At 525, the AP 105 may receive a reference waveform. The reference waveform may be transmitted by the AP 105 or by a third party device. The reference waveform may also be received by the STA 115. At 530, the AP 105 may determine spectral characteristics for the reference waveform. The AP 105 may determine the spectral characteristics from measurements of the reference waveform that are performed according to the confirmation parameters and using the HW/SW settings select by the AP 105 during measurement setup. In some cases, determining the spectral characteristics includes constructing a spectrogram of the reference waveform at 535. The AP 105 may extract the spectral characteristics from the spectrogram at 540.

At 545, the AP 105 may receive a spectral report from the STA 115. The spectral report may include spectral characteristics for the reference waveform as determined by the STA 115 according the configuration parameters and HW/SW settings selected by the AP 105. The spectral report may convey the spectral characteristics indirectly as spectrogram, or directly as extracted features of the spectrogram. At 550, the AP 105 may compute a correlation value that represents the correlation between the spectral characteristics received form the STA 115 and the spectral characteristics determined by the AP 105. In some cases, the correlation value may be Pearson's product-moment correlation coefficient, which measures the linear correlation between the received spectral characteristics and the determined spectral characteristics. The correlation coefficient may be a value between −1 and +1, where +1 represents total positive correlation, 0 represents no correlation, and −1 represents total negative correlation. Thus, when Pearson's product-moment correlation coefficient is used as the correlation value, the AP 105 may determine that the spectral characteristics are strongly correlated if the correlation coefficient is greater than a predetermined threshold (e.g., 0.8) and the AP 105 may determine that the spectral characteristics are weakly correlated is the correlation coefficient is less than the predetermined threshold. A strong correlation between spectral characteristics may indicate that the AP 105 and the STA 115 are detecting energy in the reference waveform over the same, or nearly the same, channel conditions. Thus, a strong correlation (e.g., high correlation coefficient) may indicate that the STA 115 is close to the AP 105. To determine the correlation coefficient, the AP 105 may correlate spectrograms or spectral characteristics derived from spectrograms.

At 555, the AP 105 may determine whether the spectral characteristics are strongly correlated (e.g., whether the STA 115 is within close proximity or within a threshold distance) by determining, for example, whether the correlation value is greater than a predetermined threshold. The predetermined threshold may be based on the area of relevance. For example, AP 105 may be preconfigured with one or more predetermined thresholds that correspond at least in part with a desired size for the area of relevance. If the correlation value is determined to be greater than the predetermined threshold, the AP 105 may issue an authentication grant at 585 (e.g., the AP 105 may authenticate the STA 115). In some cases, the AP 105 may, for example at 575, estimate a proximity of the STA 115 using the correlation value. The AP 105 may also, at 580, send a proximity report to the STA 115. The proximity report may indicate the sensed proximity of the STA 115 and/or may convey the authentication status of STA 115 (e.g., the proximity report may include the authentication grant). If the correlation value is determined to be less than the predetermined threshold (e.g., the STA 115 is outside the area of relevance), the AP 105 may issue an authentication denial at 570 (e.g., the AP 105 may deny authentication of the STA 115). In some cases, the AP 105 may estimate a proximity of the STA 115 using the correlation value at 560. The AP 105 may additionally or alternatively send a proximity report to the STA 115 at 565. The proximity report may indicate the sensed proximity of the STA 115 and/or may convey the authentication status of STA 115 (e.g., the proximity report may include the authentication denial).

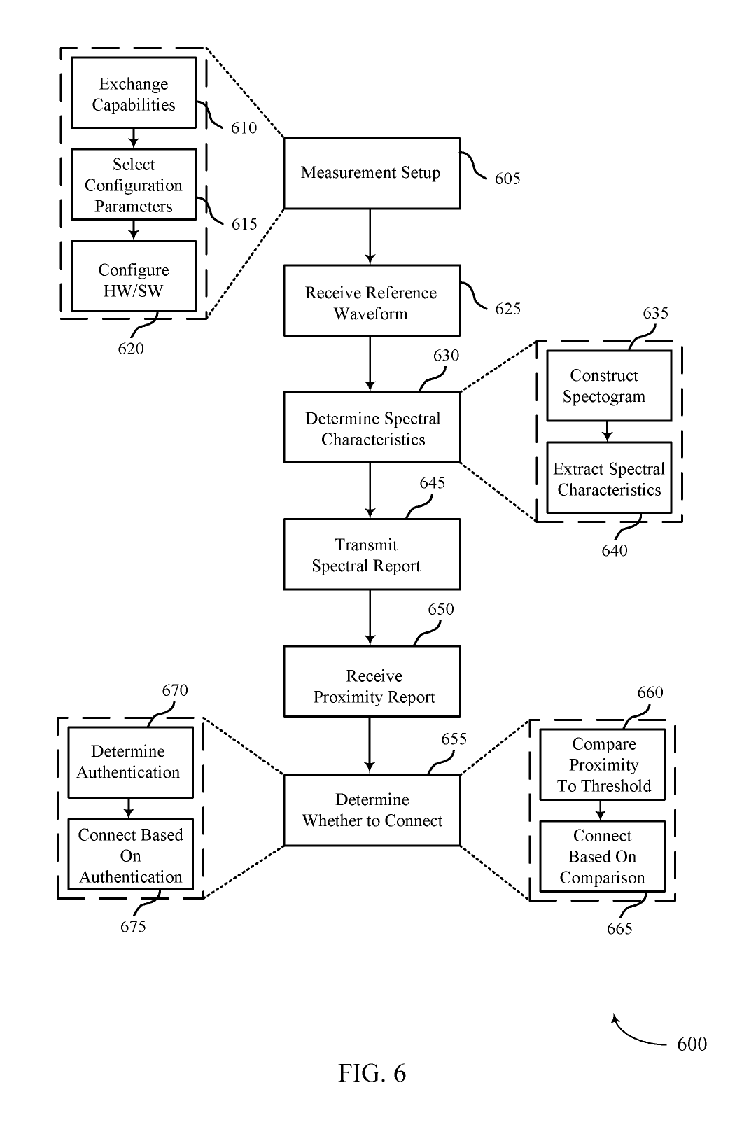

FIG. 6 illustrates an example of a flow diagram 600 that supports proximity sensing using spectral analysis. Flow diagram 600 may represent aspects of techniques performed by a STA 115 as described with reference to FIGS. 1-5. A STA 115 implementing aspects of flow diagram 600 may be authenticated by an AP 105 based on the proximity of the STA 115 as sensed by the AP 105.

At 605, the STA 115 may perform measurement setup. The measurement setup may include configuration the HW/SW settings of the STA 115, and parameters for the measurement of a reference waveform. In some cases, the measurement setup may include exchanging communications with the AP 105. For example, the measurement setup may include exchanging capabilities (e.g., HW/SW capabilities, spectral configuration setting capabilities, etc.) with the AP 105. At 615, the STA 115 may receive, in response to the capability exchange, an indication of configuration parameters to be used for spectral measurements. The configuration parameters may be based on the capabilities of the STA 115 and may include spectral and temporal parameters that characterize the profile of the measurements to be taken. At 620, the STA 115 may receive HW/SW setting configurations from the AP 105. Thus, measurements of the reference waveform may be synchronized between the STA 115 and the AP 105, performed in the same manner, and performed over the same bandwidth.

At 625, the STA 115 may receive a reference waveform. The reference waveform may be a pseudorandom signal and may be transmitted from the AP 105 or a third party device. At 630, the STA 115 may determine spectral characteristics for the reference waveform according to the parameters and settings determine during measurement setup. In some cases, determining the spectral characteristics includes constructing a spectrogram for the reference waveform at 635. The STA 115 may additionally or alternatively extract the spectral characteristics from the spectrogram at 640. At 645, the STA 115 may transmit a spectral report to the AP 105. The spectral report may be transmitted according to a schedule or based on a trigger from the AP 105. The spectral report may include the spectral characteristics determined at 630. In some cases, the spectral report may include the spectral characteristics in the form of a spectrogram. At 650, the STA 115 may receive a proximity report from the AP 105. The proximity report may include an indication of the proximity of the STA 115 to the AP 105 as sensed by the AP 105. The proximity report may additionally or alternatively include an indication of the authentication status of the STA 115. For example, the proximity report may include an authentication grant or an authentication denial.

If the proximity report includes the sensed proximity, the STA 115 may, at 655, determine whether to connect to the AP 105 or a different device associated with the authentication based on the sensed proximity. For example, the STA 115 may, at 660 compare the sensed proximity to a predetermined threshold value and make a determination of whether to establish communications with a device associated with the authentication based on the comparison. If the comparison indicates that the STA 115 is within a threshold distance of the AP 105 (e.g., the STA 115 is with the area of relevance) the STA 115 may, at 665, decide to connect to one or more devices associated with authentication. If the comparison indicates that the STA 115 is not within the threshold distance, the STA 115 may, at 665, refrain from connecting or attempting to connect to the devices associated with the authentication. If the proximity report includes an indication of the authentication status of the STA 115, the STA 115 may determine whether the STA 115 is authenticated at 670. If the STA 115 is authenticated (e.g., the proximity report includes an indication of an authentication grant) the STA 115 may, at 675, connect to one or more devices associated with the authentication grant. If the STA 115 is not authenticated (e.g., the proximity report includes an indication of an authentication denial) the STA 115 may, at 675, refrain from connecting or attempting to connect to one or more devices associated with the authentication grant, such as an AP 105.

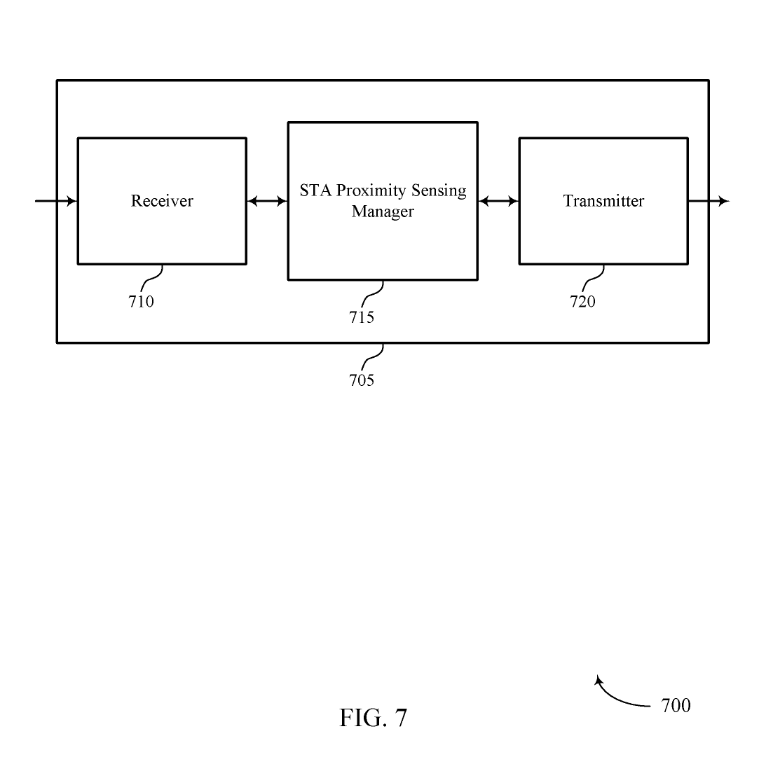

FIG. 7 shows a block diagram 700 of a wireless device 705 that supports proximity sensing using spectral analysis in accordance with various aspects of the present disclosure. Wireless device 705 may be an example of aspects of a STA 115 as described with reference to FIGS. 1-6. Wireless device 705 may include receiver 710, STA proximity sensing manager 715, and transmitter 720. Wireless device 705 may also include one or more processors memory coupled with the one or more processors, and instructions stored in the memory that are executable by the one or more processors to enable the one or more processors to perform the proximity sensing features discussed herein. Each of these components may be in communication with one another (e.g., via one or more buses).

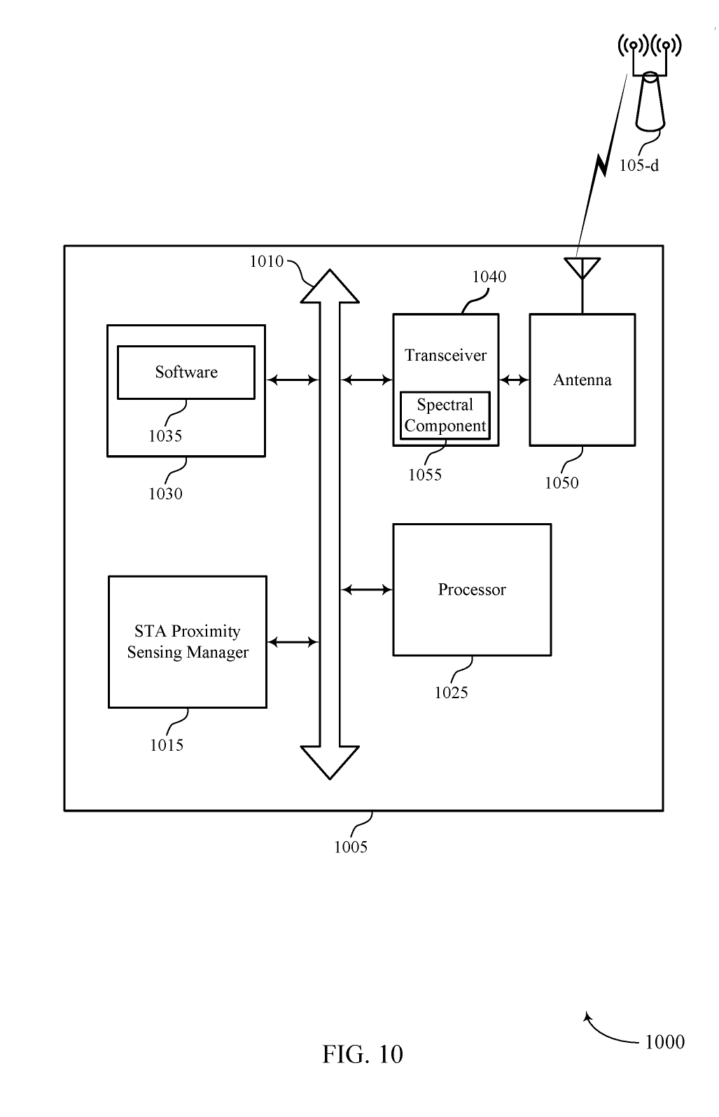

Receiver 710 may receive information such as packets, user data, or control information associated with various information channels (e.g., control channels, data channels, and information related to proximity sensing using spectral analysis, etc.). Receiver 710 may also receive a reference waveform such as described herein. In some cases, the receiver 710 may receive proximity reports from an AP 105. In some cases, receiver 710 may be coupled with a spectral analyzer (e.g., spectral component 325 such as described with reference to FIG. 3). The spectral analyzer may perform spectral analysis on received waveforms and pass spectral information along to other components of wireless device 805. Information may be passed on to other components of the wireless device 705. Receiver 710 may be an example of aspects of the transceiver 1040 described with reference to FIG. 10.

STA proximity sensing manager 715 may receive a reference waveform and determine spectral characteristics for the reference waveform. STA proximity sensing manager transmit 715 may facilitate the transmission of a report to an AP 105 that includes the determined spectral characteristics. STA proximity sensing manager 715 may facilitate the reception, in response to the transmitted report, of an indication of a sensed proximity between the AP 105 and the wireless device 705. STA proximity sensing manager 715 may be a general-purpose processor, a digital signal processor (DSP), an ASIC, an FPGA or other programmable logic device, or any combination thereof designed to perform or facilitate the operations described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). STA proximity sensing manager 715 may be an example of aspects of the STA proximity sensing manager 1015 described with reference to FIG. 10.

Transmitter 720 may transmit signals generated by other components of the device. For example, transmitter 720 may transmit channel characteristics that have been determined for a reference waveform by other components of wireless device 705. In some examples, the transmitter 720 may be collocated with a receiver 710 in a transceiver module. For example, the transmitter 720 may be an example of aspects of the transceiver 1040 described with reference to FIG. 10. The transmitter 720 may include a single antenna, or it may include a set of antennas.

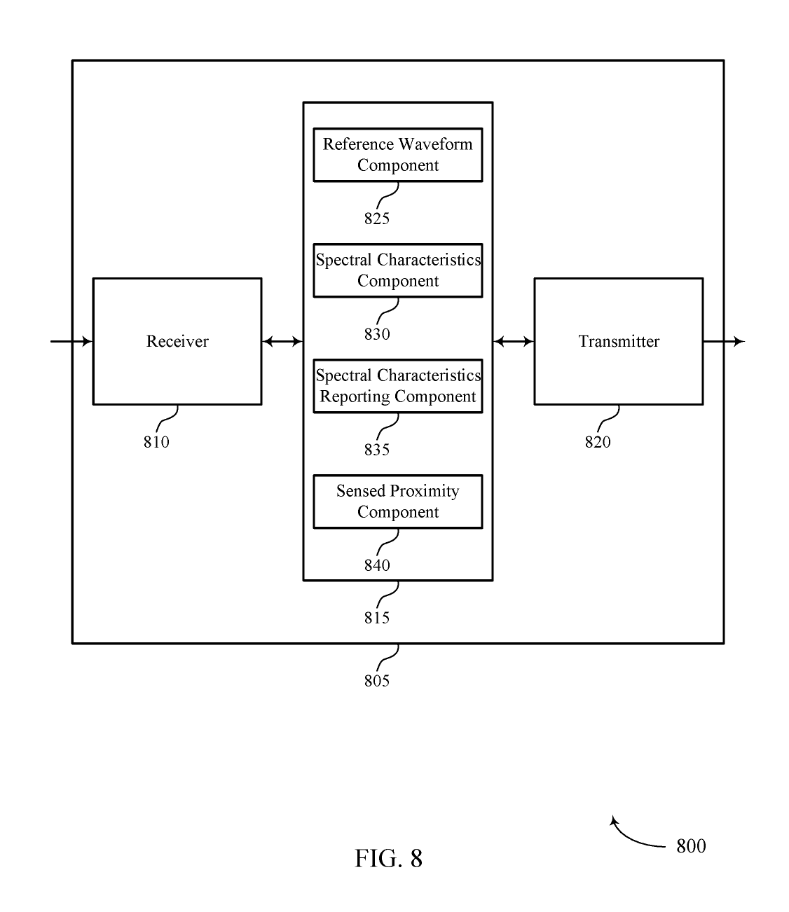

FIG. 8 shows a block diagram 800 of a wireless device 805 that supports proximity sensing using spectral analysis in accordance with various aspects of the present disclosure. Wireless device 805 may be an example of aspects of a wireless device 705 or a STA 115 as described with reference to FIGS. 1 and 7. Wireless device 805 may include receiver 810, STA proximity sensing manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to proximity sensing using spectral analysis, etc.). Receiver 810 may also receive a reference waveform such as described herein. Information may be passed on to other components of the wireless device 805. In some cases, receiver 810 may be coupled with a spectral analyzer (e.g., spectral component 325 such as described with reference to FIG. 3). The spectral analyzer may perform spectral analysis on received waveforms and pass spectral information along to other components of wireless device 805. Receiver 810 may be an example of aspects of the transceiver 1040 described with reference to FIG. 10.

STA proximity sensing manager 815 may be an example of aspects of the STA proximity sensing manager 1015 described with reference to FIG. 10. STA proximity sensing manager 815 may include reference waveform component 825, spectral characteristics component 830, spectral characteristics reporting component 835, and sensed proximity component 840.

Reference waveform component 825 may receive (e.g., from receiver 810) a reference waveform. In some cases, the reference waveform is received from an AP 105. In some cases, the reference waveform is a pseudo-random signal unknown to the station. Spectral characteristics component 830 may determine spectral characteristics for the reference waveform. In some cases, the determined spectral characteristics for the reference waveform include an RSSI, an FFT bin, a peak magnitude, a frequency, a signal level, or a noise floor, or a combination thereof. Reference waveform component 825 may pass spectral characteristics and/or spectral characteristic information to other components of wireless device 805 (e.g., to spectral characteristics reporting component 835). Reference waveform component 825 and spectral characteristics component 830 may be processors or components of one or more processors. The processor(s) may be coupled with memory and execute instructions stored in the memory that enable the processor to perform or facilitate the proximity sensing features discussed herein.

Spectral characteristics reporting component 835 may transmit, to an AP 105, a report including the determined spectral characteristics. In some cases, the AP 105 is the AP 105 that transmitted the reference waveform. Sensed proximity component 840 may receive, from the AP 105 and in response to the transmitted report, an indication of a sensed proximity between the access point and the station. In some cases, the received indication of the sensed proximity includes at least a proximity report, or an authentication grant, and/or an authentication denial. Spectral characteristics reporting component 835 and sensed proximity component 840 may be processors or components of one or more processors. The processor(s) may be coupled with memory and execute instructions stored in the memory that enable the processor to perform or facilitate the proximity sensing features discussed herein.

Transmitter 820 may transmit signals generated by other components of the wireless device 805. For instance, transmitter 820 may transmit a proximity report to the AP 105. In some examples, the transmitter 820 may be collocated with a receiver 810 in a transceiver module. For example, the transmitter 820 may be an example of aspects of the transceiver 1040 described with reference to FIG. 10. The transmitter 820 may include a single antenna, or it may include a set of antennas.

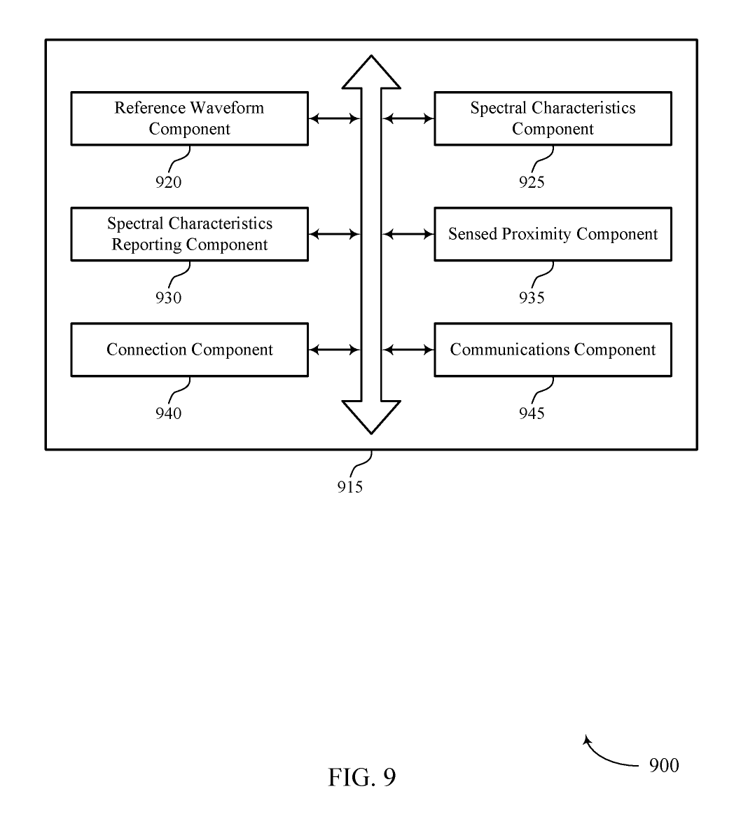

FIG. 9 shows a block diagram 900 of a STA proximity sensing manager 915 that supports proximity sensing using spectral analysis in accordance with various aspects of the present disclosure. The STA proximity sensing manager 915 may be an example of aspects of a STA proximity sensing manager 715, a STA proximity sensing manager 815, or a STA proximity sensing manager 1015 described with reference to FIGS. 7, 8, and 10. The STA proximity sensing manager 915 may include reference waveform component 920, spectral characteristics component 925, spectral characteristics reporting component 930, sensed proximity component 935, connection component 940, and communications component 945. Each of these modules may communicate, directly or indirectly, with one another (e.g., via one or more buses).

Reference waveform component 920 may receive a reference waveform (e.g., from an AP 105 or from a third party device). Spectral characteristics component 925 may determine spectral characteristics for the reference waveform. Spectral characteristics reporting component 930 may transmit, to an AP 105, a report including the determined spectral characteristics. Sensed proximity component 935 may receive, from the AP 105 and in response to the transmitted report, an indication of a sensed proximity between the access point and the STA 115. In some cases, the received indication of the sensed proximity includes at least a proximity report, an authentication grant, and/or an authentication denial. Connection component 940 may connect to the AP 105 based on the received indication of the sensed proximity. Communications component 945 may exchange measurement capabilities and/or configuration parameters for determining the spectral characteristics with the AP 105. Reference waveform component 920, spectral characteristics component 925, Spectral characteristics reporting component 930, and sensed proximity component 935 may be processors or components of one or more processors. The processor(s) may be coupled with memory and execute instructions stored in the memory that enable the processor to perform or facilitate the proximity sensing features discussed herein.

FIG. 10 shows a diagram of a system 1000 including a device 1005 that supports proximity sensing using spectral analysis in accordance with various aspects of the present disclosure. Device 1005 may be an example of or include the components of wireless device 705, wireless device 805, or a STA 115 as described above, e.g., with reference to FIGS. 1-8. Device 1005 may include components for bi-directional voice and data communications including components for transmitting and receiving communications, including STA proximity sensing manager 1015, processor 1025, memory 1030, software 1035, transceiver 1040, and antenna 1050.

Processor 1025 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 1025 may be configured to operate a memory array using a memory controller. In other cases, a memory controller may be integrated into processor 1025. Processor 1025 may be configured to execute computer-readable instructions stored in a memory to perform various functions (e.g., function or tasks supporting proximity sensing using spectral analysis).1025.

Memory 1030 may include random access memory (RAM) and read only memory (ROM). The memory 1030 may store computer-readable, computer-executable software 1035 including instructions that, when executed, cause the processor to perform various functions described herein. In some cases, the memory 1030 can contain, among other things, a Basic Input-Output system (BIOS) which may control basic hardware and/or software operation such as the interaction with peripheral components or devices.

Software 1035 may include code to implement aspects of the present disclosure, including code to support proximity sensing using spectral analysis. Software 1035 can be stored in a non-transitory computer-readable medium such as system memory or other memory. In some cases, the software 1035 may not be directly executable by the processor but may cause a computer (e.g., when compiled and executed) to perform functions described herein.

Transceiver 1040 may communicate bi-directionally (e.g., with AP 105-d), via one or more antennas, wired, or wireless links as described above. For example, the transceiver 1040 may represent a wireless transceiver and may communicate bi-directionally with another wireless transceiver. Transceiver 1040 may include or be coupled with a spectral component 1055, which may be an example of a spectral component 325 described with reference to FIG. 3. The transceiver 1040 may also include a modem to modulate the packets and provide the modulated packets to the antennas for transmission, and to demodulate packets received from the antennas. In some cases, the device 1005 may include a single antenna 1050. However, in some cases the device 1005 may have more than one antenna 1050, which may be capable of concurrently transmitting or receiving multiple wireless transmissions.

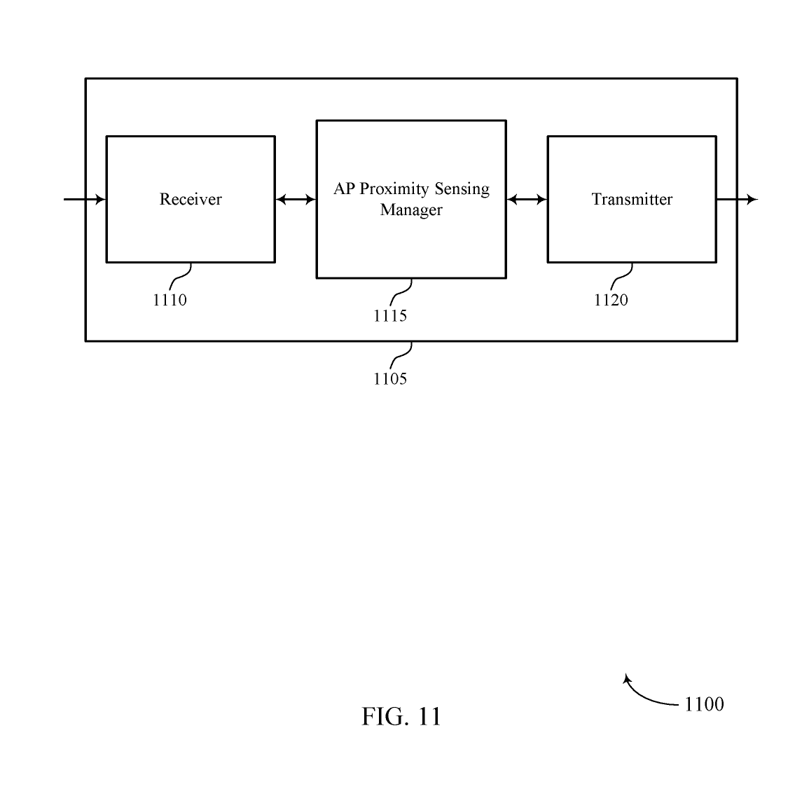

FIG. 11 shows a block diagram 1100 of a wireless device 1105 that supports proximity sensing using spectral analysis in accordance with various aspects of the present disclosure. Wireless device 1105 may be an example of aspects of an AP 105 as described with reference to FIG. 1. Wireless device 1105 may include receiver 1110, AP proximity sensing manager 1115, and transmitter 1120. Wireless device 1105 may also include one or more processors, memory coupled with the one or more processors, and instructions stored in the memory that are executable by the one or more processors to enable the one or more processors to perform the proximity sensing discussed herein. Each of these components may be in communication with one another (e.g., via one or more buses).

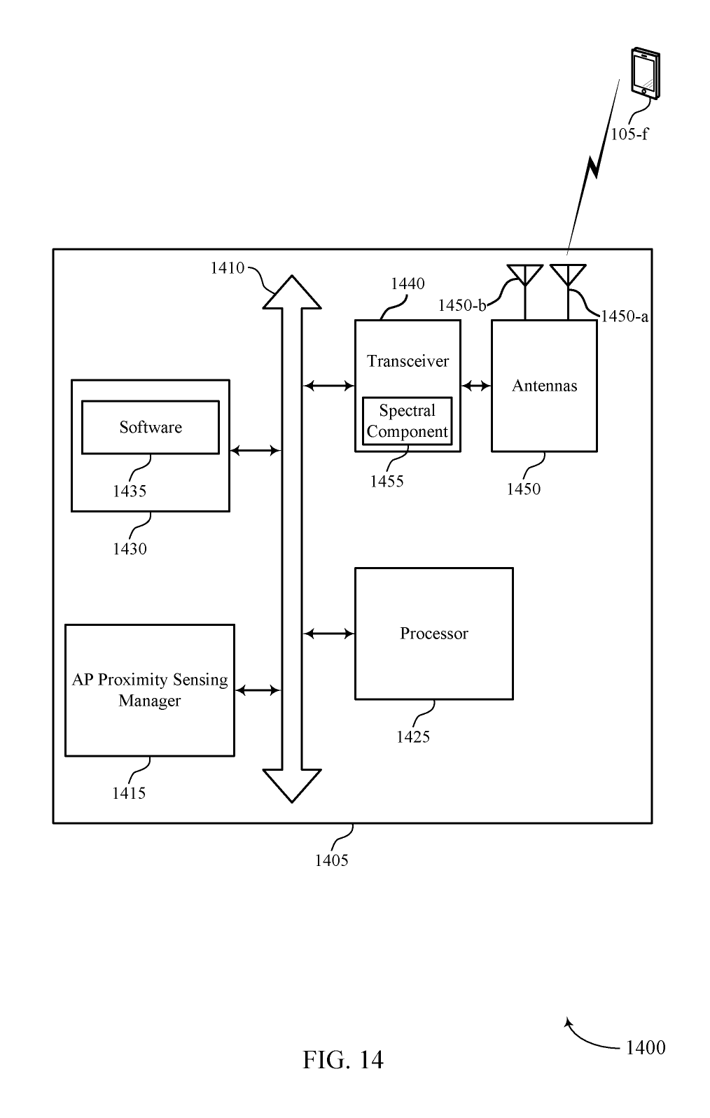

Receiver 1110 may receive information such as packets, user data, or control information associated with various information channels (e.g., control channels, data channels, and information related to proximity sensing using spectral analysis, etc.). In some examples, receiver, 1110 may receive a reference waveform (e.g., transmitted from the wireless device 1105 or a third party device). In some cases, receiver 1110 may be coupled with a spectral analyzer (e.g., spectral component 325 such as described with reference to FIG. 3). The spectral analyzer may perform spectral analysis on received waveforms and pass spectral information along to other components of wireless device 1105. In some cases, receiver 1110 may receive a spectral report (e.g., from a STA 115). Information may be passed on to other components of the wireless device 1105. The receiver 1110 may be an example of aspects of the transceiver 1440 described with reference to FIG. 14.

AP proximity sensing manager 1115 may receive a reference waveform at the access point, determine spectral characteristics for the received reference waveform, receive, from a station, a report of spectral characteristics for the reference waveform as received at the station, and sense a proximity of the station to the access point based on a comparison of the determined spectral characteristics for the received reference waveform and the spectral characteristics for the reference waveform as received at the station. AP proximity sensing manager 1115 may be a general-purpose processor, a DSP, an ASIC, an FPGA or other programmable logic device, or any combination thereof designed to perform or facilitate the operations described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). AP proximity sensing manager 1115 may be an example of aspects of the AP proximity sensing manager 1415 described with reference to FIG. 14.

Transmitter 1120 may transmit signals generated by other components of the device. In some cases, transmitter 1120 may transmit a reference waveform such as described herein. Transmitter 1120 may additionally or alternatively transmit an indication of sensed proximity (e.g., a proximity report). In some examples, the transmitter 1120 may be collocated with a receiver 1110 in a transceiver module. For example, the transmitter 1120 may be an example of aspects of the transceiver 1440 described with reference to FIG. 14. The transmitter 1120 may include a single antenna, or it may include a set of antennas.

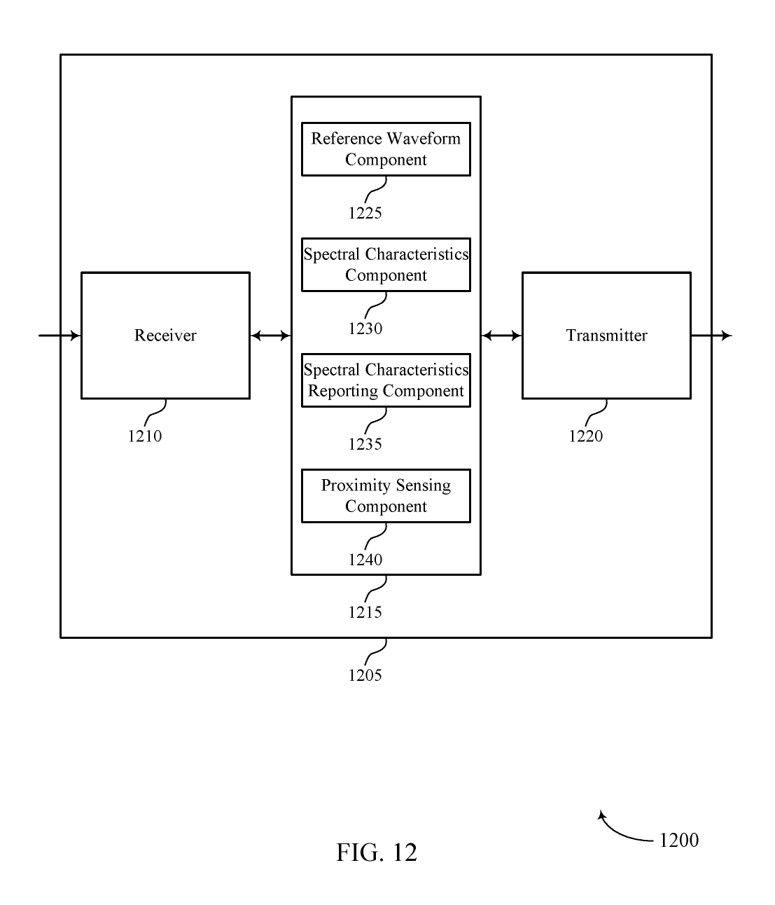

FIG. 12 shows a block diagram 1200 of a wireless device 1205 that supports proximity sensing using spectral analysis in accordance with various aspects of the present disclosure. Wireless device 1205 may be an example of aspects of a wireless device 1105 or an AP 105 as described with reference to FIGS. 1 and 11. Wireless device 1205 may include receiver 1210, AP proximity sensing manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to proximity sensing using spectral analysis, etc.). In some cases, receiver 1210 may receive a reference waveform. Information may be passed on to other components of the device. In some cases, receiver 1210 may be coupled with a spectral analyzer (e.g., spectral component 325 such as described with reference to FIG. 3). The spectral analyzer may perform spectral analysis on received waveforms and pass spectral information along to other components of wireless device 1205. The receiver 1210 may be an example of aspects of the transceiver 1440 described with reference to FIG. 14.

AP proximity sensing manager 1215 may be an example of aspects of the AP proximity sensing manager 1415 described with reference to FIG. 14. AP proximity sensing manager 1215 may include reference waveform component 1225, spectral characteristics component 1230, spectral characteristics reporting component 1235, and proximity sensing component 1240.

Reference waveform component 1225 facilitate (e.g., via transmitter 1220) transmission the reference waveform. Reference waveform component 1225 may facilitate reception (e.g., via receiver 1210) of a reference waveform. The reference waveform may be received from a third party device or from wireless device 1205. In some cases, the reference waveform is a pseudo-random signal known to the access point and unknown to the wireless device 1205. Reference waveform component 1225 may be a component of a processor or a processor. The processor may be coupled with memory and execute instructions stored in the memory that enable the processor to perform or facilitate the proximity sensing features discussed herein.

Spectral characteristics component 1230 may determine spectral characteristics for the received reference waveform. Spectral characteristics reporting component 1235 may receive (e.g., from a STA 115) a report of spectral characteristics for the reference waveform as received at the STA 115. Proximity sensing component 1240 may sense a proximity of the STA 115 to the wireless device 1205 based on a comparison of the determined spectral characteristics for the received reference waveform and the spectral characteristics for the reference waveform as received at the STA 115. In some cases, the comparison includes correlating the determined spectral characteristics for the reference waveform with the spectral characteristics for the reference waveform as received at the STA 115. Spectral characteristics component 1230, spectral characteristics reporting component 1235, and proximity sensing component 1240, may be a components of a processor or processors. The processors may be coupled with memory and execute instructions stored in the memory that enable the processor to perform or facilitate the proximity sensing features discussed herein.

Transmitter 1220 may transmit signals generated by other components of the device. In some cases, transmitter 1220 may transmit a reference waveform. In some cases, transmitter 1220 may transmit an indication of sensed proximity. Transmitter 1220 may be an transmitter 315 such as described with reference to FIG. 3 and may be coupled with one or more antennas. In some examples, the transmitter 1220 may be collocated with a receiver 1210 in a transceiver module. For example, the transmitter 1220 may be an example of aspects of the transceiver 1440 described with reference to FIG. 14. The transmitter 1220 may include a single antenna, or it may include a set of antennas.

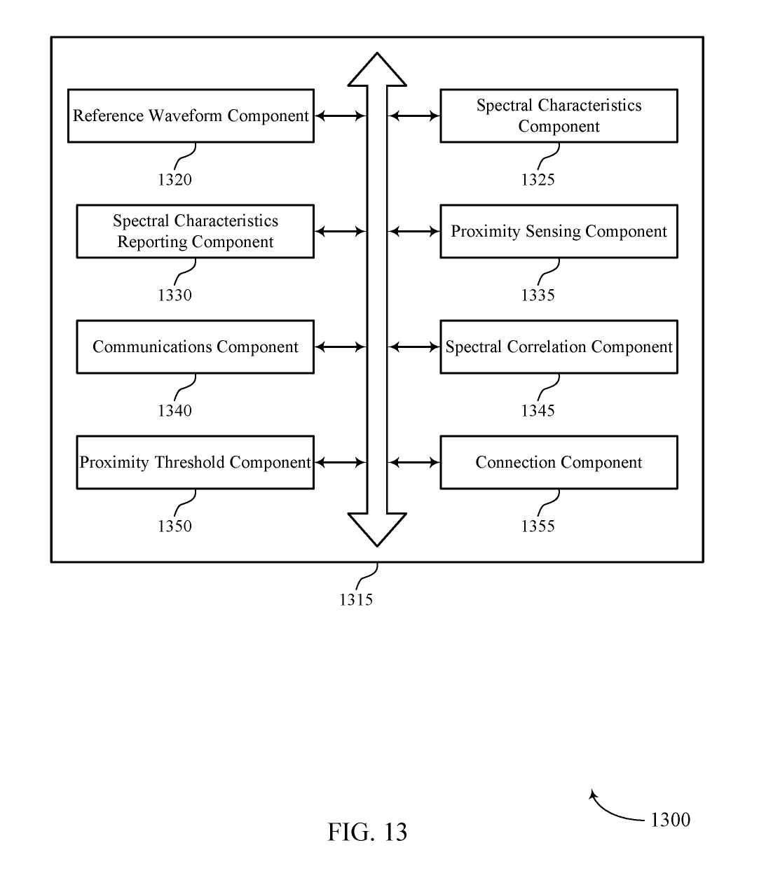

FIG. 13 shows a block diagram 1300 of an AP proximity sensing manager 1315 that supports proximity sensing using spectral analysis in accordance with various aspects of the present disclosure. The AP proximity sensing manager 1315 may be an example of aspects of an AP proximity sensing manager 1115 or an AP proximity sensing manager 1215 described with reference to FIGS. 11 and 12. The AP proximity sensing manager 1315 may include reference waveform component 1320, spectral characteristics component 1325, spectral characteristics reporting component 1330, proximity sensing component 1335, communications component 1340, spectral correlation component 1345, proximity threshold component 1350, and connection component 1355. Each of these modules may communicate, directly or indirectly, with one another (e.g., via one or more buses).

Reference waveform component 1320 may facilitate reception of a reference waveform and/or facilitate transmission of a reference waveform. Spectral characteristics component 1325 may determine spectral characteristics for a received reference waveform. In some cases, spectral characteristics component 1325 may construct a first spectrogram based on the determined spectral characteristics. Spectral characteristics reporting component 1330 may receive, from a STA 115, a report of spectral characteristics for the reference waveform as received at the STA 115. Reference waveform component 1320 and spectral characteristics component 1325 may be processors or components of a processor. The processor may be coupled with memory and execute instructions stored in the memory that enable the processor to perform or facilitate the communication pattern detection and mitigation features discussed herein.

Proximity sensing component 1335 may sense a proximity of the STA 115 to the AP 105 based on a comparison of the determined spectral characteristics for the received reference waveform and the spectral characteristics for the reference waveform as received at the STA 115. In some cases, the comparison includes correlating the determined spectral characteristics for the reference waveform with the spectral characteristics for the reference waveform as received at the station. Proximity sensing component 1335 may be a processor or a component of a processor. The processor may be coupled with memory and execute instructions stored in the memory that enable the processor to perform or facilitate the communication pattern detection and mitigation features discussed herein.

Spectral correlation component 1345 may determine a correlation value from a correlation between the first spectrogram and a second spectrogram constructed based on the spectral characteristics for the reference waveform as received at the STA 115. In such cases, sensing the proximity of the STA 115 to the AP 105 is based on the determined correlation value. Proximity threshold component 1350 may determine when the sensed proximity satisfies a predetermined threshold and when the sensed proximity fails to satisfy a predetermined threshold. Communications component 1340 may transmit, to the STA 115, an indication of the sensed proximity. In some cases, communications component 1340 may exchange measurement capabilities and/or configuration parameters for determining the spectral characteristics with the STA 115 (e.g., prior to transmitting the reference waveform).

Connection component 1355 may allow a connection with the STA 115 based on the determination that the sensed proximity satisfies the predetermined threshold. Connection component 1355 may refrain from allowing a connection with the station based on the determination that the sensed proximity does not satisfy the predetermined threshold. Spectral correlation component 1345, proximity threshold component 1350, and connection component 1355 may be processors or components of a processor. The processor may be coupled with memory and execute instructions stored in the memory that enable the processor to perform or facilitate the communication pattern detection and mitigation features discussed herein.

FIG. 14 shows a diagram of a system 1400 including a device 1405 that supports proximity sensing using spectral analysis in accordance with various aspects of the present disclosure. Device 1405 may be an example of or include the components of wireless device 1105, wireless device 1205, or an AP 105 as described above, e.g., with reference to FIGS. 1, 11 and 12. Device 1405 may include components for bi-directional voice and data communications including components for transmitting and receiving communications, including AP proximity sensing manager 1415, processor 1425, memory 1430, software 1435, transceiver 1440, and antenna 1450.

Processor 1425 may include an intelligent hardware device, (e.g., a general-purpose processor, a DSP, a CPU, a microcontroller, an ASIC, a FPGA, a programmable logic device, a discrete gate or transistor logic component, a discrete hardware component, or any combination thereof). In some cases, processor 1425 may be configured to operate a memory array using a memory controller. In other cases, a memory controller may be integrated into processor 1425. Processor 1425 may be configured to execute computer-readable instructions stored in a memory to perform various functions (e.g., function or tasks supporting proximity sensing using spectral analysis).

Memory 1430 may include RAM and ROM. The memory 1430 may store computer-readable, computer-executable software 1435 including instructions that, when executed, cause the processor to perform the various proximity sensing functions described herein. In some cases, the memory 1430 can contain, among other things, a BIOS which may control basic hardware and/or software operation such as the interaction with peripheral components or devices.

Software 1435 may include code to implement aspects of the present disclosure, including code to support proximity sensing using spectral analysis. Software 1435 can be stored in a non-transitory computer-readable medium such as system memory or other memory. In some cases, the software 1435 may not be directly executable by the processor but may cause a computer (e.g., when compiled and executed) to perform functions described herein.

Transceiver 1440 may communicate bi-directionally (e.g., with STA 115-f), via one or more antennas, wired, or wireless links as described above. For example, the transceiver 1440 may represent a wireless transceiver and may communicate bi-directionally with another wireless transceiver. Transceiver 1440 may include or be coupled with a spectral component 1455, which may be an example of a spectral component 325 described with reference to FIG. 3. Transceiver 1440 may also be coupled with antennas 1450, which may include antenna 1450-a and antenna 1450-b. Antenna 1450-a may be used to transmit a reference waveform and antenna 1450-b may be used to receive the reference waveform. The transceiver 1440 may also include a modem to modulate the packets and provide the modulated packets to the antennas 1450 for transmission, and to demodulate packets received from the antennas. In some cases, the device 1405 may include a single antenna 1450. However, in some cases the device may have more than one antenna 1450, which may be capable of concurrently transmitting or receiving multiple wireless transmissions.

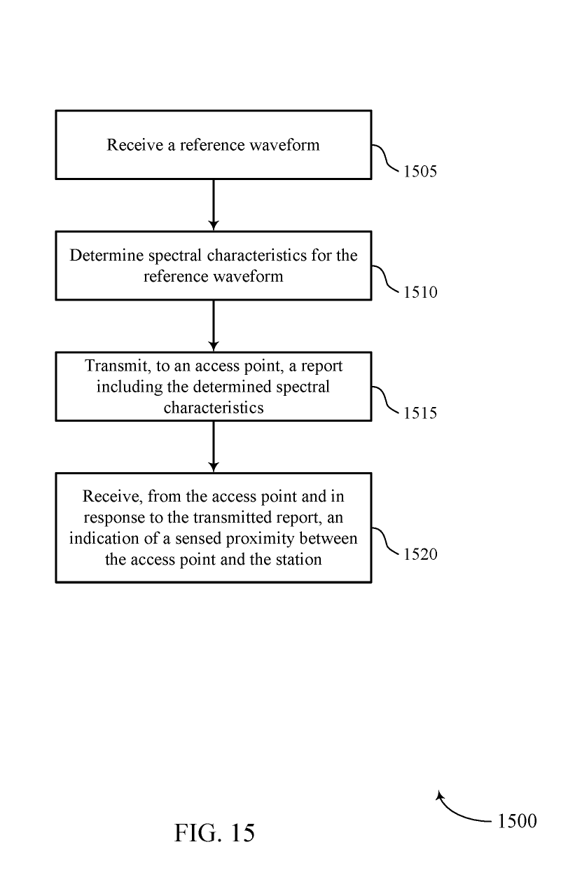

FIG. 15 shows a flowchart illustrating a method 1500 for proximity sensing using spectral analysis in accordance with various aspects of the present disclosure. The operations of method 1500 may be implemented by a STA 115 or its components as described herein. For example, the operations of method 1500 may be performed by a STA proximity sensing manager as described with reference to FIGS. 7 through 9. In some examples, a STA 115 may execute a set of codes to control the functional elements of the STA 115 to perform the functions described below. Additionally or alternatively, the STA 115 may perform aspects the functions described below using special-purpose hardware.

At block 1505, the STA 115 may receive a reference waveform. The operations of block 1505 may be performed according to the methods described with reference to FIGS. 1 through 6. In certain examples, aspects of the operations of block 1505 may be performed by a reference waveform component as described with reference to FIGS. 7 through 9. At block 1510, the STA 115 may determine spectral characteristics for the reference waveform. The operations of block 1510 may be performed according to the methods described with reference to FIGS. 1 through 6. In certain examples, aspects of the operations of block 1510 may be performed by a spectral characteristics component as described with reference to FIGS. 7 through 9.

At block 1515, the STA 115 may transmit, to an AP 105, a report including the determined spectral characteristics. The operations of block 1515 may be performed according to the methods described with reference to FIGS. 1 through 6. In certain examples, aspects of the operations of block 1515 may be performed by a spectral characteristics reporting component as described with reference to FIGS. 7 through 9. At block 1520, the STA 115 may receive, from the AP 105 and in response to the transmitted report, an indication of a sensed proximity between the AP 105 and the STA 115. The operations of block 1520 may be performed according to the methods described with reference to FIGS. 1 through 6. In certain examples, aspects of the operations of block 1520 may be performed by a sensed proximity component as described with reference to FIGS. 7 through 9.

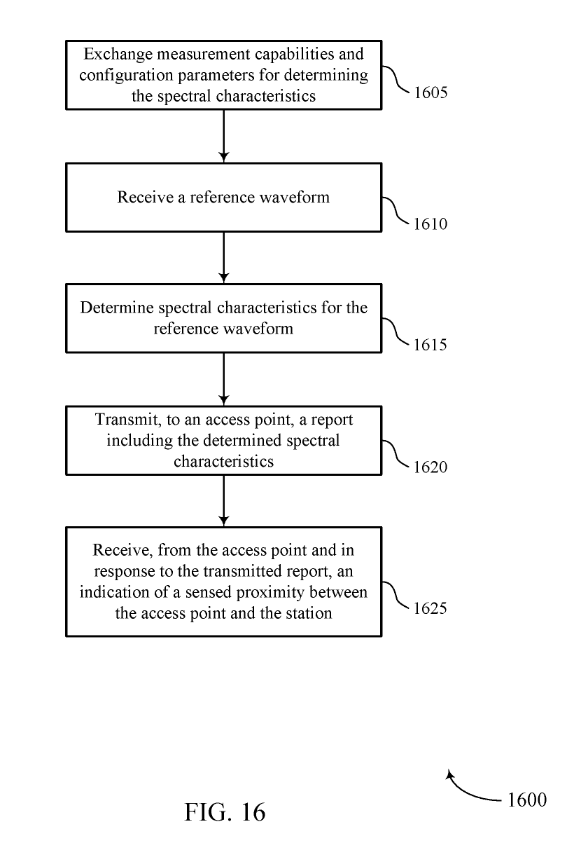

FIG. 16 shows a flowchart illustrating a method 1600 for proximity sensing using spectral analysis in accordance with various aspects of the present disclosure. The operations of method 1600 may be implemented by a STA 115 or its components as described herein. For example, the operations of method 1600 may be performed by a STA proximity sensing manager as described with reference to FIGS. 7 through 9. In some examples, a STA 115 may execute a set of codes to control the functional elements of the STA 115 to perform the functions described below. Additionally or alternatively, the STA 115 may perform aspects the functions described below using special-purpose hardware.

At block 1605, the STA 115 may exchange measurement capabilities and configuration partakers for determine the spectral characteristics. The operations of block 1605 may be performed according to the methods described with reference to FIGS. 1 through 6. In certain examples, aspects of the operations of block 1605 may be performed by a communications component as described with reference to FIG. 9. At block 1610, the STA 115 may receive a reference waveform. The operations of block 1610 may be performed according to the methods described with reference to FIGS. 1 through 6. In certain examples, aspects of the operations of block 1610 may be performed by a reference waveform component as described with reference to FIGS. 7 through 9.

At block 1615, the STA 115 may determine spectral characteristics for the reference waveform. The spectral characteristics may be determined using configuration parameters received from the AP 105. The operations of block 1615 may be performed according to the methods described with reference to FIGS. 1 through 6. In certain examples, aspects of the operations of block 1615 may be performed by a spectral characteristics component as described with reference to FIGS. 7 through 9. At block 1620, the STA 115 may transmit, to an access point, a report including the determined spectral characteristics. The operations of block 1620 may be performed according to the methods described with reference to FIGS. 1 through 6. In certain examples, aspects of the operations of block 1620 may be performed by a spectral characteristics reporting component as described with reference to FIGS. 7 through 9.

At block 1625, the STA 115 may receive, from the access point and in response to the transmitted report, an indication of a sensed proximity between the access point and the station. The operations of block 1625 may be performed according to the methods described with reference to FIGS. 1 through 6. In certain examples, aspects of the operations of block 1625 may be performed by a sensed proximity component as described with reference to FIGS. 7 through 9.

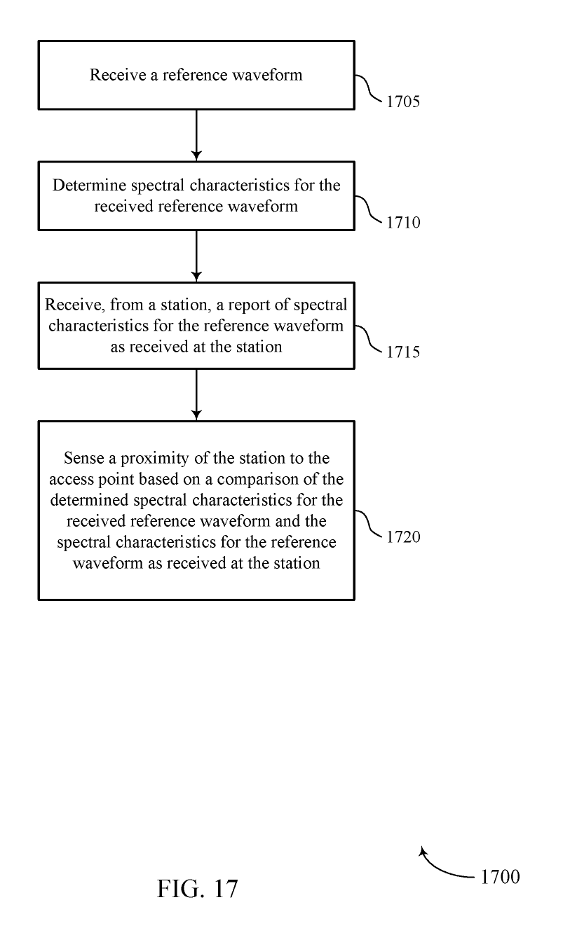

FIG. 17 shows a flowchart illustrating a method 1700 for proximity sensing using spectral analysis in accordance with various aspects of the present disclosure. The operations of method 1700 may be implemented by an AP 105 or its components as described herein. For example, the operations of method 1700 may be performed by an AP proximity sensing manager as described with reference to FIGS. 11 through 13. In some examples, an AP 105 may execute a set of codes to control the functional elements of the AP 105 to perform the functions described below. Additionally or alternatively, the AP 105 may perform aspects the functions described below using special-purpose hardware.

At block 1705, the AP 105 may receive a reference waveform. The operations of block 1705 may be performed according to the methods described with reference to FIGS. 1 through 6. In certain examples, aspects of the operations of block 1705 may be performed by a reference waveform component as described with reference to FIGS. 11 through 13. At block 1710, the AP 105 may determine spectral characteristics for the received reference waveform. The operations of block 1710 may be performed according to the methods described with reference to FIGS. 1 through 6. In certain examples, aspects of the operations of block 1710 may be performed by a spectral characteristics component as described with reference to FIGS. 11 through 13.

At block 1715, the AP 105 may receive, from a STA 115, a report of spectral characteristics for the reference waveform as received at the STA 115. The operations of block 1715 may be performed according to the methods described with reference to FIGS. 1 through 6. In certain examples, aspects of the operations of block 1715 may be performed by a spectral characteristics reporting component as described with reference to FIGS. 11 through 13. At block 1720, the AP 105 may sense a proximity of the STA 115 to the AP 105 based on a comparison of the determined spectral characteristics for the received reference waveform and the spectral characteristics for the reference waveform as received at the STA 115. The operations of block 1720 may be performed according to the methods described with reference to FIGS. 1 through 6. In certain examples, aspects of the operations of block 1720 may be performed by a proximity sensing component as described with reference to FIGS. 11 through 13.

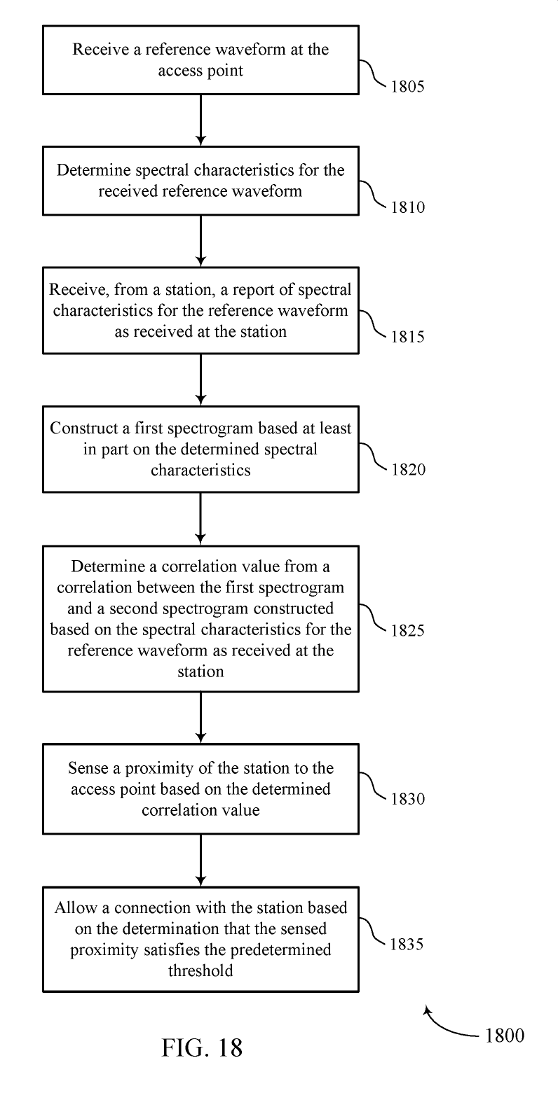

FIG. 18 shows a flowchart illustrating a method 1800 for proximity sensing using spectral analysis in accordance with various aspects of the present disclosure. The operations of method 1800 may be implemented by an AP 105 or its components as described herein. For example, the operations of method 1800 may be performed by an AP proximity sensing manager as described with reference to FIGS. 11 through 13. In some examples, an AP 105 may execute a set of codes to control the functional elements of the AP 105 to perform the functions described below. Additionally or alternatively, the AP 105 may perform aspects the functions described below using special-purpose hardware.

At block 1805, the AP 105 may receive a reference waveform. The operations of block 1805 may be performed according to the methods described with reference to FIGS. 1 through 6. In certain examples, aspects of the operations of block 1805 may be performed by a reference waveform component as described with reference to FIGS. 11 through 13. At block 1810, the AP 105 may determine spectral characteristics for the received reference waveform. The operations of block 1810 may be performed according to the methods described with reference to FIGS. 1 through 6. In certain examples, aspects of the operations of block 1810 may be performed by a spectral characteristics component as described with reference to FIGS. 11 through 13. At block 1815, the AP 105 may receive, from a STA 115, a report of spectral characteristics for the reference waveform as received at the STA 115. The operations of block 1815 may be performed according to the methods described with reference to FIGS. 1 through 6. In certain examples, aspects of the operations of block 1815 may be performed by a spectral characteristics reporting component as described with reference to FIGS. 11 through 13.

At block 1820, the AP 105 may construct a first spectrogram based at least in part on the determined spectral characteristics. The operations of block 1820 may be performed according to the methods described with reference to FIGS. 1 through 6. In certain examples, aspects of the operations of block 1820 may be performed by a spectral correlation component as described with reference to FIGS. 11 through 13. At block 1825, the AP 105 may determine a correlation value from a correlation between the first spectrogram and a second spectrogram constructed based on the spectral characteristics for the reference waveform as received at the STA 115. The operations of block 1825 may be performed according to the methods described with reference to FIGS. 1 through 6. In certain examples, aspects of the operations of block 1825 may be performed by a spectral correlation component as described with reference to FIGS. 11 through 13.

At block 1830, the AP 105 may sense a proximity of the station to the AP 105 based on a comparison of the determined spectral characteristics for the received reference waveform and the spectral characteristics for the reference waveform as received at the STA 115. The operations of block 1830 may be performed according to the methods described with reference to FIGS. 1 through 6. In certain examples, aspects of the operations of block 1830 may be performed by a proximity sensing component as described with reference to FIGS. 11 through 13. At block 1835, the AP 105 may allow a connection with the STA 115 based on the determination that the sensed proximity satisfies the predetermined threshold. The operations of block 1835 may be performed according to the methods described with reference to FIGS. 1 through 6. In certain examples, aspects of the operations of block 1835 may be performed by a connection component as described with reference to FIGS. 11 through 13.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, in a system comprising:
a memory that stores instructions; and
a processor coupled with the memory, wherein the processor and memory are configured to:
receive a reference waveform;
determine spectral characteristics for the reference waveform;
transmit, to an access point, a report including the determined spectral characteristics; and
receive, from the access point and in response to the transmitted report, an indication of a sensed proximity between the access point and the apparatus.

2. The apparatus of claim 1, wherein the reference waveform is received from the access point.

3. The apparatus of claim 1, wherein the received indication of the sensed proximity comprises at least one of a proximity report, an authentication grant, or an authentication denial, or a combination thereof.

4. The apparatus of claim 1, wherein the processor and memory are further configured to:
connect to the access point based at least in part on the received indication of the sensed proximity.

5. The apparatus of claim 1, wherein the processor and memory are further configured to:
exchange, with the access point, at least measurement capabilities, or configuration parameters for determining the spectral characteristics, or a combination thereof.

6. The apparatus of claim 1, wherein the reference waveform is a pseudo-random signal unknown to the apparatus.

7. The apparatus of claim 1, wherein the determined spectral characteristics for the reference waveform comprise at least one of a received signal strength indicator (RSSI), a fast Fourier transform (FFT) bin, a peak magnitude, a frequency, a signal level, or a noise floor, or a combination thereof.

8. The apparatus of claim 1, wherein the apparatus is a wireless communication terminal and further comprises an antenna and a transceiver.

9. An apparatus for wireless communication, in a system comprising:
a memory that stores instructions; and
a processor coupled with the memory, wherein the processor and memory are configured to:
receive a reference waveform at the apparatus;
determine spectral characteristics for the received reference waveform;
receive, from a station, a report of spectral characteristics for the reference waveform as received at the station; and
sense a proximity of the station to the apparatus based at least in part on a comparison of the determined spectral characteristics for the received reference waveform and the spectral characteristics for the reference waveform as received at the station.

10. The apparatus of claim 9, wherein the processor and memory are further configured to:
transmit, to the station, an indication of the sensed proximity.

11. The apparatus of claim 9, wherein the processor and memory are further configured to:
transmit the reference waveform by the apparatus, wherein the apparatus receives the transmitted reference waveform.

12. The apparatus of claim 9, wherein the processor and memory are configured to sense the proximity by being configured to:
correlate the determined spectral characteristics for the reference waveform with the spectral characteristics for the reference waveform as received at the station.

13. The apparatus of claim 12, wherein the processor and memory are configured to correlate the determined spectral characteristics by being configured to:
construct a first spectrogram based at least in part on the determined spectral characteristics; and
determine a correlation value from a correlation between the first spectrogram and a second spectrogram constructed based at least in part on the spectral characteristics for the reference waveform as received at the station, wherein sensing the proximity of the station to the apparatus is based at least in part on the determined correlation value.

14. The apparatus of claim 9, wherein the processor and memory are further configured to:
determine that the sensed proximity satisfies a predetermined threshold; and
allow a connection with the station based at least in part on the determination that the sensed proximity satisfies the predetermined threshold.

15. The apparatus of claim 9, wherein the processor and memory are further configured to:
determine that the sensed proximity fails to satisfy a predetermined threshold; and
refrain from allowing a connection with the station based at least in part on the determination that the sensed proximity does not satisfy the predetermined threshold.

16. The apparatus of claim 9, wherein the processor and memory are further configured to:
exchange, with the station, at least measurement capabilities, or configuration parameters for determining the spectral characteristics, or a combination thereof.

17. The apparatus of claim 9, wherein the reference waveform is a pseudo-random signal known to the apparatus and unknown to the station.

18. The apparatus of claim 9, wherein the apparatus is an access point and further comprises an antenna and a transceiver.

19. The apparatus of claim 18, wherein the access point further comprises:
an auxiliary transmitter to transmit the reference waveform.

20. A method for wireless communication at a station, comprising:
receiving a reference waveform;
determining spectral characteristics for the reference waveform;
transmitting, to an access point, a report including the determined spectral characteristics; and
receiving, from the access point and in response to the transmitted report, an indication of a sensed proximity between the access point and the station.

21. The method of claim 20, wherein the reference waveform is received from the access point.

22. The method of claim 20, wherein the received indication of the sensed proximity comprises at least one of a proximity report, an authentication grant, or an authentication denial, or a combination thereof.

23. The method of claim 20, further comprising:
connecting to the access point based at least in part on the received indication of the sensed proximity.

24. The method of claim 20, further comprising:
exchanging, with the access point, at least measurement capabilities, or configuration parameters for determining the spectral characteristics, or a combination thereof.

25. The method of claim 20, wherein the determined spectral characteristics for the reference waveform comprise at least one of a received signal strength indicator (RSSI), a fast Fourier transform (FFT) bin, a peak magnitude, a frequency, a signal level, or a noise floor, or a combination thereof.

26. A method for wireless communication at an access point, comprising:
receiving a reference waveform at the access point;
determining spectral characteristics for the received reference waveform;
receiving, from a station, a report of spectral characteristics for the reference waveform as received at the station; and
sensing a proximity of the station to the access point based at least in part on a comparison of the determined spectral characteristics for the received reference waveform and the spectral characteristics for the reference waveform as received at the station.

27. The method of claim 26, further comprising:
transmitting, to the station, an indication of the sensed proximity.

28. The method of claim 26, further comprising:
transmitting the reference waveform by the access point, wherein the access point receives the transmitted reference waveform.

29. The method of claim 26, wherein the comparison comprises:
correlating the determined spectral characteristics for the reference waveform with the spectral characteristics for the reference waveform as received at the station.

30. The method of claim 26, further comprising:
determining that the sensed proximity satisfies a predetermined threshold; and
allowing a connection with the station based at least in part on the determination that the sensed proximity satisfies the predetermined threshold.
